(19) United States
(12) Patent Application Publication
(10) Pub. No.: US 2006/0154140 A1
(43) Pub. Date: Jul. 13, 2006

(54) Separator for organic electrolyte battery, process for producing the same and organic electrolyte battery including the separator

(75) Inventors: Hiroyuki Yamamoto, Kakogawa-shi (JP); Hitoshi Tateno, Kako-gun (JP); Toshio Kamisasa, Akashi-shi (JP)

Correspondence Address: HAMRE, SCHUMANN, MUELLER & LARSON, P.C., P.O. BOX 2902-0902, MINNEAPOLIS, MN, 55402, US

(73) Assignee: DAIWABO CO., LTD., OSAKA-SHI (JP)

(21) Appl. No.: 10/532,322

(22) PCT Filed: Oct. 23, 2003
(86) PCT No.: PCT/JP03/13520

§ 371 Date: Apr. 22, 2005

(30) Foreign Application Priority Data
Oct. 24, 2002 (JP) 2002-310152

(51) Int. Cl. H01M 2/16; D04H 13/00

(52) U.S. Cl. 429/142; 429/254; 442/333

(57) ABSTRACT

An organic electrolyte battery separator is composed of a nonwoven comprising a heat-and-humidity gelling resin capable of gelling by heating in the presence of moisture and another fiber. The other fiber is fixed with a gel material obtained by causing the heat-and-humidity gelling resin to gel under heat and humidity. The nonwoven has a mean flow pore diameter of 0.3 μm to 5 μm and a bubble point pore diameter of 3 μm to 20 μm as measured in accordance with ASTM F 316 86. Thereby, the other fiber constituting the nonwoven can be fixed with the heat-and-humidity gelling resin, thereby making it possible to obtain a desired mean flow pore diameter and bubble point pore diameter. As a result, an organic electrolyte battery having a high level of safety, less occurrence of a short circuit, high battery characteristics is provided.

### TECHNICAL FIELD

The present invention relates to a battery separator made of a nonwoven that can be used in an organic electrolyte battery, particularly preferably in a lithium ion secondary battery. The present invention also relates to an organic electrolyte battery comprising the battery separator.

### BACKGROUND ART

Recent advances in IT (information technology) and environmental issues have spurred the development of secondary batteries, such as, for example, an alkaline secondary battery and an organic electrolyte secondary battery. Particularly, a lithium ion secondary battery employing an organic electrolyte, which has high voltage, high capacity and high power, and in addition, light weight, has had an impact on the market, which demands small-size and light-weight products. Further, this battery has been developed for hybrid electric vehicles (HEV) and pure electric vehicles (PEV). This lithium ion secondary battery comprises a positive electrode made of a composite metal oxide material that can absorb/store and release lithium ions, a negative electrode made of a carbon material or the like that can absorb/store and release lithium ions, a separator, and an organic electrolyte. Particularly, in this lithium ion secondary battery, an electrode that is made by electrochemically alloying lithium with another metal in the presence of an electrolyte may be used in order to improve battery performance. However, this alloy electrode has a problem in that fine powder of lithium alloy is generated in the alloying process and the alloy powder penetrates through the separator and reaches the other electrode, resulting in a short circuit (hereinafter referred to as a fine powder short). There is particularly a demand for a separator with a small pore diameter to prevent fine powder short circuits. On the other hand, repeated charging and discharging of a battery causes needle-like formation of the fine powder, which grows on the electrode and finally penetrates through the separator, resulting in a short circuit (hereinafter referred to as a dendritic short circuit). Therefore, the separator requires a sheet having a high level of resistance to piercing (hereinafter referred to as puncture strength).

Further, the number of electrodes or the overall electrode area per the volume of a battery is one of the factors that determine the lifetime of a secondary battery. The battery life may be prolonged by decreasing the thickness of the electrode as well as the thickness of the separator to increase the number of electrodes or the overall electrode area. Therefore, there is a demand for a thin separator.

At the present time, a fine-porous film is used, which satisfies all of the above-described conditions. However, the production process of the fine-porous film is complicated and expensive. Therefore, nonwovens, which are inexpensive and satisfy the puncture strength and thickness requirements, have been studied in place of the fine-porous film.

Various nonwovens for use in an organic electrolyte battery separator have been studied. For example, Patent Publications 1 and 2 listed below propose nonwovens with a small pore diameter, which are prepared by a meltblown method. Particularly, Patent Publication 1 proposes a nonwoven with a bubble point pore diameter of 30 μm or less, specifically a nonwoven with a bubble point pore diameter of 25 μm or less, which is a composite nonwoven of polypropylene and polyethylene prepared by the meltblown method.

Besides the meltblown method, for example, Patent Publication 3 listed below proposes a wetlaid nonwoven with a bubble point pore diameter of 9 μm, which is made of small fineness polyethylene terephthalate fiber. Further, as an organic electrolyte battery separator made of a wetlaid nonwoven containing a splittable composite fiber, for example, Patent Publication 4 listed below proposes a nonaqueous electrolyte battery separator that is prepared by mixing a splittable composite fiber containing an ethylene-vinyl alcohol copolymer as at least one component with a hot melt fiber, splitting the splittable composite fiber and attaching polyalkylene denatured polysiloxane to the resultant wetlaid nonwoven via a chemical bond. Patent Publication 5 listed below proposes a nonaqueous electrolytic solution battery separator that is made of a wetlaid nonwoven that mainly contains a plate-like ultrafine fiber prepared by dividing a splittable composite fiber.

Patent Publications 6 to 9 propose separators made of a nonwoven that is prepared by bonding an ethylene-vinyl alcohol copolymer under heat and humidity.
Patent Publication 1: JP H7-138866A (claim 2)
Patent Publication 2: JP 2000-123815A
Patent Publication 3: JP 2002-151037A (page 6, examples 1 and 2)
Patent Publication 4: JP 2000-285895A
Patent Publication 5: JP 2001-283821A
Patent Publication 6: JP H3-257755A
Patent Publication 7: JP S63-235558A
Patent Publication 8: JP H5-109397A
Patent Publication 9: JP H8-138645A

However, the above-described battery separators have the following problems: Firstly, the meltblown nonwoven disclosed in Patent Publication 1 is formed of a polyolefin fiber that is not drawn in the process, so that its single fiber strength is low. Therefore, this nonwoven is prone to be torn during assembly of a battery, and if assembled, its low puncture strength leads to a low level of capability of preventing the dendritic short circuit. In Patent Publication 2, it is attempted to improve the strength of the nonwoven by using polyphenylene sulfide to suppress the occurrence of defects during assembly of a battery. However, polyphenylene sulfide is expensive, i.e. it does not contribute to cost-cutting. The separator of Patent Publication 3 has a bubble point pore diameter of 9 μm and has a certain level of fine powder short circuit preventing capability, however, its mean flow pore diameter is not discussed therein and is not satisfactory. When component fibers are bonded together with heat to form a nonwoven, the process needs to be performed at a temperature that is equal to or higher than about the melting point of a binder resin. At such a temperature, however, thermal shrinkage occurs in association with heat melting of the binder fiber. As a result, the nonwoven undergoes thermal shrinkage, resulting in a decrease in yield of production of the nonwoven (hereinafter simply referred to as a “yield”). Specifically, variations in mass per unit area, or weight per unit area, thickness or the like, or irregular pore diameters are likely to occur in the nonwoven. Therefore, the electrolytic solution cannot be kept uniform, or both a fine powder short circuit and a dendritic short circuit are likely to occur, resulting in a high defect rate of a battery (hereinafter also referred to as a “battery defect rate”). When pressure bonding using a thermal roller or the like is performed in order to decrease the pore diameter and thickness of a nonwoven, significant fusion bonding occurs on a surface of the nonwoven (dense surface) and less inside the nonwoven (coarse inside), leading to an increase in the battery defect rate. Further, the electrolytic solution is not kept uniform, so that an internal resistance of the battery is increased. In the separator of Patent Publication 4, a wetlaid nonwoven having a low mass per unit area of 12 to 14 g/m² and a predetermined thickness, which contains a splittable composite fiber, is produced, and thereafter, the wetlaid nonwoven is immersed in an aqueous solution of polyalkylene denatured polysiloxane, thereby attempting to decrease the micropore diameter of the nonwoven. However, for such a low-mass per unit area nonwoven, it is difficult to produce a nonwoven having a uniform mean flow pore diameter and bubble point pore diameter. In fact, the nonwoven has a large variation in pore diameter, leading to instable puncture strength. Further, a splittable composite fiber containing an ethylene-vinyl alcohol copolymer as at least one component is mixed with a hot melt fiber to obtain a wetlaid nonwoven, which is in turn subjected to a dry heat calender process at a processing temperature that causes the hot melt fiber to exhibit its adhesion ability. Therefore, only the hot melt fiber contributes to adhesion ability, so that the puncture strength is insufficient. In the separator of Patent Publication 5, a splittable composite fiber made of two components, i.e., polypropylene/polyester, nylon 66/polyester, and polypropylene/polyethylene, is split into plate-like microfine fibers, which are in turn subjected only to a heat calender process at a temperature that is below the melting point of the lower-melting point component. Therefore, it is difficult to obtain a nonwoven having a uniform mean flow pore diameter and bubble point pore diameter, resulting in a nonwoven having a significant variation in pore diameter. Therefore, no stable puncture strength is acquired. Although Patent Publications 6 to 9 disclose separators containing fibers that are bonded under heat and humidity, all the separators are intended to be used for an alkaline battery. It is difficult to obtain a separator having a small pore diameter that is required for an organic electrolyte battery.

### DISCLOSURE OF INVENTION

The present invention is provided to solve the above-described problems. An object of the present invention is to provide an organic electrolyte battery separator made of a nonwoven that can be produced inexpensively, has an excellent yield in production, has an excellent level of electrolytic solution holding ability, and can prevent a fine powder short circuit and a dendritic short circuit when incorporated into a battery (i.e., a low battery defect rate), in place of nonwovens that conventionally have been proposed as organic electrolyte battery separators. Another object of the present invention is to provide an organic electrolyte battery that has an excellent level of safety, has a short circuit less often, and has excellent battery characteristics.

The organic electrolyte battery separator of the present invention is made of a nonwoven containing a resin that can gel by heating in the presence of moisture (hereinafter referred to as a “heat-and-humidity gelling resin”) and another fiber. The other fiber is fixed by the heat-and-humidity gelling resin that gels under heat and humidity to form a gel material (hereinafter referred to as a “gel material”). The nonwoven has a mean flow pore diameter of 0.3 μm to 5 μm and a bubble point pore diameter of 3 μm to 20 μm as measured in accordance with ASTM F 316 86.

The organic electrolyte battery separator of the present invention can be produced using the following method. Specifically, a method for producing an organic electrolyte battery separator comprising a heat-and-humidity gelling fiber in which a resin capable of gelling by heating in the presence of moisture (hereinafter referred to as a “heat-and-humidity gelling resin”) is present on at least a portion of a surface of the fiber, and another fiber, has at least the following steps:

A. preparing a nonwoven sheet comprising a heat-and-humidity gelling fiber and another fiber;

B. subjecting the nonwoven sheet to a hydrophilic treatment;

C. providing moisture to the hydrophilic-treated nonwoven sheet (hereinafter referred to as a “hydrophilic nonwoven sheet”) to obtain a water-containing sheet; and

D. subjecting the water-containing sheet to a heat-and-humidity treatment (hereinafter referred to as a “gel processing”) using a heat treatment device that is set to a certain temperature within a range of no less than a temperature at which the heat-and-humidity gelling resin gels and no more than “the melting point of the heat-and-humidity gelling resin −20° C.”, to cause the heat-and-humidity gelling resin to gel, and fixing the other fiber using the heat-and-humidity gelling resin gel.

An organic electrolyte battery of the present invention is obtained by incorporating the separator.

### BRIEF DESCRIPTION OF DRAWINGS

FIG. 1 is a cross-sectional view showing a method of measuring a contact angle on a surface of a nonwoven used in an example of the present invention.

FIG. 2 is a 200×SEM micrograph of a surface of a nonwoven sheet obtained in Example 1 of the present invention.

FIGS. 3A to 3D are 200×SEM micrographs of a surface of a battery separator obtained in Example 1 of the present invention.

FIG. 4 is a 500×SEM micrograph of a section of the battery separator obtained in Example 1 of the present invention.

FIGS. 5A and 5B are 300×SEM micrographs of a surface of a nonwoven sheet obtained in Example 5 of the present invention. FIGS. 5C and 5D are 300× cross-sectional photographs of a surface of the nonwoven sheet obtained in Example 5 of the present invention.

FIGS. 6A and 6B are 300×SEM micrographs of a surface of a battery separator obtained in Example 5 of the present invention. FIGS. 6C and 6D are 1000× cross-sectional photographs of a surface of the battery separator obtained in Example 5 of the present invention.

1: glass plate, 2: sample, 3: pure water

### BEST MODE FOR CARRYING OUT THE INVENTION

The present inventors have diligently researched to conceive that a separator made of a nonwoven that excellently resists a fine powder short circuit can be obtained by establishing an appropriate mean flow pore diameter range and bubble point pore diameter range, but not sufficiently by only decreasing a pore diameter. It was found that this can be achieved by reducing shrinkage of a nonwoven when subjected to a thermal treatment to obtain a micropore diameter and fixing a binder resin in a thickness direction of the nonwoven substantially uniformly. To obtain such a nonwoven, a heat-and-humidity gelling resin is caused to gel using a particular thermal processing method to fix other fiber(s). Thereby, the mass per unit area and thickness irregularity are reduced. Further, the puncture strength is large, and a variation in the puncture strength is suppressed. Therefore, the yield of production of the separator is excellent, and the battery defect rate is low. Particularly, the dendritic short circuit prevention ability is also excellent. Furthermore, it is found that the separator is less expensive than conventional fine-porous films. Hereinafter, the organic electrolyte battery separator of the present invention will be described in detail.

To obtain a nonwoven with a small pore diameter, a method of pressing and spreading a resin that has been softened or melted by heating, using a means for thermally bonding with a predetermined pressure or more, such as thermal rolling or the like, to fill a gap between fibers, may be used. However, conventional heat-melting resins need to be heated to the melting point of the heat-melting resin or more. In this case, a dimension of the nonwoven is significantly changed due to thermal shrinkage associated with the melting of the heat-melting resin. As a result, the yield is reduced, or variations in the mass per unit area, the thickness, the pore diameter, the puncture strength or the like are increased, so that the battery defect rate, particularly the short circuit prevention ability, is low. When a thermal roller or the like is used, fusion bonding is likely to occur significantly on a surface of a nonwoven (dense surface) and less inside the nonwoven (coarse inside). Therefore, it is difficult for the electrolytic solution holding ability to be uniform, likely leading to an increase in the battery defect rate.

Therefore, in the present invention, a heat-and-humidity gelling resin that becomes a gel and swells in the presence of moisture is used in place of conventional heat-melting resins, and another fiber constituting a nonwoven is fixed using a gel material that is obtained by gelation of the heat-and-humidity gelling resin under heat and humidity so that an appropriate mean flow pore diameter range and bubble point pore diameter range are obtained. By fixing the other fiber constituting the nonwoven using the gel material, a puncture strength of the separator is increased, thereby resisting tearing during assembly of a battery and obtaining an excellent level of dendritic short circuit prevention ability. Further, the fine powder short circuit prevention ability is caused to be excellent by establishing an appropriate mean flow pore diameter range and bubble point pore diameter range. As used herein, the gel material indicates a resin (solid material) that is solidified after gelation of the heat-and-humidity gelling resin under heat and humidity. In the organic electrolyte battery separator of the present invention, the other fiber constituting the separator is fixed using the gel material.

Further, when the organic electrolyte battery separator of the present invention is produced, by uniformly dispersing the heat-and-humidity gelling resin into the nonwoven sheet, it is made more likely to obtain an appropriate mean flow pore diameter range and bubble point pore diameter range. Furthermore, by causing the nonwoven sheet to hold moisture uniformly before gel processing, it is made possible to cause the heat-and-humidity gelling resin provided in the nonwoven sheet to gel substantially uniformly, whereby the component fibers can be fixed more uniformly using the gel material. Therefore, it is made more likely to obtain an appropriate mean flow pore diameter range and bubble point pore diameter range. Still furthermore, by performing the gel processing in the presence of moisture at a temperature range of no less than the gelling temperature of the heat-and-humidity gelling resin and no more than “the melting point of the heat-and-humidity gelling resin −20° C.”, it is made possible to perform the processing at a temperature that does not cause the heat-and-humidity gelling resin and the other component fiber to substantially shrink, whereby a shrinkage phenomenon associated with melting of the heat-and-humidity gelling resin and the other component fiber is suppressed. As a result, it is possible to obtain a separator that has a small change in dimensions during processing of the nonwoven, small variations in the mass per unit area, the thickness and the like, leading to an excellent yield and a small battery defect rate.

Particularly, when the heat-and-humidity gelling resin having such a property is used and is processed under a high pressure using a thermal roller or the like, the heat-and-humidity gelling resin on an entire nonwoven sheet is pressed and spread while being caused to be instantaneously gelled, to penetrate into the nonwoven sheet. Therefore, the fiber constituting the nonwoven can be fixed substantially uniformly in an in-plane direction and a thickness direction of the nonwoven using the gel material. As a result, a separator that has a large tensile strength and puncture strength and an appropriate mean flow pore diameter range and bubble point pore diameter range of the nonwoven, and a small variation in the puncture strength, can be obtained.

As used herein, the nonwoven sheet indicates a web and a nonwoven that are in a form before gel processing. The web indicates a carded web, an airlaid web, a wetlaid web, or the like, in which component fibers are not bonded together. The nonwoven is produced by a method in which the web is subjected to an entanglement process, such as a bonding process (thermal bonding, etc.), a hydroentangling process, a needlepunching process, or the like, so that component fibers are bonded together. The same is true of the following description.

The resin (heat-and-humidity gelling resin) capable of gelling by heating in the presence of moisture, which is used in the organic electrolyte battery separator of the present invention, indicates a resin that gels and swells in the presence of moisture at a temperature of 60° C. or more to become a gel material, thereby fixing other fiber(s) constituting a nonwoven. Since batteries are used under various circumstances, the stability of the battery is deteriorated if the resin gels at less than 60° C. Any resin that has such a property may be used. Among other things, an ethylene-vinyl alcohol copolymer having a specific composition is particularly preferable in terms of heat-and-humidity gel processing ability, water resistance, and dimensional stability during processing of a nonwoven.

The ethylene-vinyl alcohol copolymer is a copolymer that is obtained by saponification of an ethylene-vinyl acetate copolymer. The saponification degree is preferably 95% or more. A more preferable lower limit of the saponification degree is 98%. When the saponification degree is less than 95%, the thread-forming ability is deteriorated when a fiber is produced. Also, gelation is likely to occur even at low temperature, likely leading to a trouble in fiber production and a nonwoven processing step. Further, when incorporated into a battery, the chemical stability in electrolytic solution is poor, or the stability at high temperature is deteriorated.

The ethylene-vinyl alcohol copolymer preferably has an ethylene content in a range of 20 mol % to 50 mol %. A more preferable lower limit of the ethylene content is 25 mol %. A more preferable upper limit of the ethylene content is 45 mol %. When the ethylene content is less than 20 mol %, the thread-forming ability is poor and the ethylene-vinyl alcohol copolymer is likely to be softened, likely leading to a problem in fiber production and a nonwoven processing step. Further, when incorporated into a battery, the chemical stability in the electrolytic solution is poor, or the stability at high temperature is deteriorated. On the other hand, when the ethylene content exceeds 50 mol %, the heat-and-humidity gelling temperature is increased. In this case, the processing temperature has to be increased up to about the melting point in order to obtain a desired mean flow pore diameter and bubble point pore diameter. As a result, there is a possibility that the dimension stability of the nonwoven is adversely influenced.

The heat-and-humidity gelling resin may be in any form, including powder, emulsion, film, a single component fiber containing the heat-and-humidity gelling resin, a composite fiber containing a combination of the heat-and-humidity gelling resin and another resin, and the like. The heat-and-humidity gelling resin is likely in the form of a fiber in terms of a nonwoven production step. The fiber may have any cross-sectional shape, including a circle, a hollow shape, an irregular shape, an ellipse, a star, a flat shape, and the like. A circle is preferable in terms of ease of fiber production. The composite fiber may have any composite form, including a concentric sheath-core type, an eccentric sheath-core type, a side-by-side type, a splittable type, an islands-in-the-sea type, and the like. In the case of the composite fiber, it is important for the heat-and-humidity gelling resin to cover at least a portion of a surface of the fiber during gel processing of the heat-and-humidity gelling resin. Particularly, a splittable composite fiber in which the heat-and-humidity gelling resin and another resin other than the heat-and-humidity gelling resin are disposed adjacent to each other is preferable. A cross-sectional shape of the fiber is preferably of a radial type, a comb type, a matrix type, a laminar type, or the like, in which each segment is independent, in terms of segmentation.

Also in the case of the splittable composite fiber made of the heat-and-humidity gelling resin and another resin, the other resin is preferably not compatible with the heat-and-humidity gelling resin, although it may be highly compatible with the heat-and-humidity gelling resin. This is because the non-compatible resin can be detached and split so that the heat-and-humidity gelling fiber containing the heat-and-humidity gelling resin is changed into microfibers, whereby the component fibers are fixed more uniformly, contributing to establishment of an appropriate mean flow pore diameter range and bubble point pore diameter range. The other resin is not particularly limited and may be any resin that is not compatible with the heat-and-humidity gelling resin. Among other things, the other resin is preferably polypropylene, polyethylene, polymethylpentane, or a copolymer thereof, or the like. Particularly, polypropylene is preferable in terms of fiber production and stability with respect to battery electrolytic solution.

The heat-and-humidity gelling resin preferably accounts for 10 mass % to 50 mass % of the whole separator. A more preferable lower limit of the heat-and-humidity gelling resin content is 15 mass %. An even more preferable lower limit of the content is 20 mass %. A more preferable upper limit of the content is 45 mass %. An even more preferable upper limit of the content is 40 mass %. A most preferable upper limit of the content is 35 mass %. When the heat-and-humidity gelling resin content is less than 10 mass %, it is difficult for the gel material to be spread uniformly into the nonwoven and sufficiently penetrate between the fibers, in spite of gel processing. As a result, it is difficult to obtain an appropriate mean flow pore diameter range and bubble point pore diameter range, likely leading to a variation in the puncture strength. Particularly, it is difficult to decrease the bubble point pore diameter. Further, a portion in which the other fiber constituting the nonwoven is fixed is reduced, whereby there is a possibility that the puncture strength is also reduced. On the other hand, when the heat-and-humidity gelling resin content exceeds 50 mass %, a surface of the nonwoven is likely to become a film, so that the electrolytic solution holding ability is reduced, and therefore, there is a possibility that an internal resistance of the battery is increased. Further, the heat-and-humidity gelling resin becomes likely to adhere to a roller or the like during gel processing, likely leading to poor performance in a nonwoven production step.

The fiber constituting the nonwoven, other than the heat-and-humidity gelling resin, used in the battery separator of the present invention preferably has a fiber diameter of 15 μm or less. A more preferable upper limit of the fiber diameter is 14 μm. An even more preferable upper limit of the fiber diameter is 13 μm. On the other hand, the lower limit of the fiber diameter of the other fiber is not particularly limited as long as the nonwoven production step can be performed in the range. Particularly taking into consideration the dispersion ability of the fiber in a wetlaying process, the fiber diameter is preferably 1 μm or more. When the fiber diameter of the other fiber exceeds 15 μm, it is difficult to obtain an appropriate mean flow pore diameter and bubble point pore diameter of the nonwoven by gelation of the heat-and-humidity gelling resin. As a result, a fine powder short circuit is likely to occur. As used herein, when a cross-section of a fiber is in the shape of a circle, the fiber diameter refers to the diameter of the circle. When the cross-sectional shape is a non-circle, the fiber diameter refers to a maximum thickness in a minor axis direction. The maximum thickness in the minor axis of a fiber whose cross-section is in the shape of a non-circle indicates a maximum height when the fiber is placed, the way it is, with a major axis of the fiber being parallel to a horizontal plane. The term “the way it is” indicates that it is assumed that no external force is applied to the fiber other than gravity. Note that when it is difficult to determine a fiber diameter using the above-described method, a fineness of a fiber is measured and a circular cross-section having such a fineness is assumed, and the diameter of the circle can be regarded as the fiber diameter.

The average fiber diameter of the other fiber constituting the nonwoven other than the heat-and-humidity gelling resin is preferably 10 μm or less. A more preferable upper limit of the average fiber diameter is 9 μm. An even more preferable upper limit of the average fiber diameter is 8 μm. On the other hand, a lower limit of the average fiber diameter of the other fiber is not particularly limited as long as the nonwoven can be produced in the range. The average fiber diameter of the other fiber is preferably 1 μm or more for reasons of stability in fiber production. When the average fiber diameter exceeds 10 μm, it is difficult to obtain a separator having desired ranges of mean flow pore diameter and bubble point pore diameter. As a result, a fine powder short circuit or the like is likely to occur.

Among the fibers constituting the nonwoven used in the organic electrolyte battery separator of the present invention, a fiber containing the heat-and-humidity gelling fiber in which the heat-and-humidity gelling resin constitutes a portion of fiber surface preferably has a fiber diameter of 15 μm or less. A more preferable upper limit of the fiber diameter is 14 μm. An even more preferable upper limit of the fiber diameter is 13 μm. All fibers constituting the nonwoven preferably have a diameter within this range. This is because when the fiber diameter exceeds 15 μm, it is difficult to obtain the nonwoven having desired ranges of mean flow pore diameter and bubble point pore diameter during gel processing. On the other hand, a lower limit of the fiber diameter is not particularly limited as long as the nonwoven can be produced in the range. Particularly taking into consideration the dispersion ability of the fiber in a wetlaying process, the fiber diameter is preferably 1 μm or more.

Particularly, in order to obtain desired ranges of mean flow pore diameter and bubble point pore diameter, when the heat-and-humidity gelling resin is a fiber, a fiber diameter of the heat-and-humidity gelling fiber is preferably small, specifically 6 μm or less. A more preferable upper limit of the heat-and-humidity gelling fiber is 5 μm. An even more preferable upper limit of the heat-and-humidity gelling fiber is 4 μm. When the fiber diameter of the heat-and-humidity gelling fiber is 6 μm or less, the heat-and-humidity gelling fiber that becomes a gel material spreads to form a film without filling a gap between fibers more than necessary, so that other fiber(s) can be fixed. A lower limit of the fiber diameter of the heat-and-humidity gelling fiber is not particularly limited. However, the fiber diameter of the heat-and-humidity gelling fiber is preferably 1 μm or more for reasons of stability in production. To obtain such a microfine fiber, for example, it is preferable that a splittable composite fiber containing the heat-and-humidity gelling resin and its non-compatible resin is provided and split. For example, an about 8- to 24-splittable type fiber spinning nozzle may be used to obtain a splittable composite fiber of about 0.5 to 3 dtex, which in turn may be split.

Also, when the heat-and-humidity gelling resin is a fiber, it is important for all fibers constituting the nonwoven to have an average fiber diameter of 10 μm or less. A more preferable upper limit of the average fiber diameter is 9 μm. An even more preferable upper limit of the average fiber diameter is 8 μm. On the other hand, a lower limit of the average fiber diameter of all the fibers is not particularly limited as long as the nonwoven can be produced in the range. The average fiber diameter is preferably 1 μm or more for reasons of stability in fiber production. When the average fiber diameter exceeds 10 μm, it is difficult to obtain a separator having desired ranges of mean flow pore diameter and bubble point pore diameter. As a result, a fine powder short circuit or the like is likely to occur.

It is also preferable that the other fiber constituting the organic electrolyte battery separator of the present invention includes a high-strength fiber having a single fiber strength of 4.5 cN/dtex or more for the purpose of increasing the puncture strength of the nonwoven to further improve the dendritic short circuit prevention ability. The single fiber strength of the high-strength fiber is more preferably 5 cN/dtex or more, even more preferably 5.5 cN/dtex or more. When the single fiber strength is less than 4.5 cN/dtex, the other fiber is not likely to contribute to the puncture strength, likely leading to a dendritic short circuit. It is also preferable that the melting point of the high-strength fiber is greater than or equal to a temperature that is lower by 20° C. than the melting point of the heat-and-humidity gelling resin. More preferably, the melting point of the high-strength fiber is greater than or equal to a temperature that is lower by 15° C. than the melting point of the heat-and-humidity gelling resin. An upper limit of the melting point of the high-strength fiber is not particularly limited. For example, when the high-strength fiber is a polyolefin fiber, the melting point is preferably 250° C. or less. When the melting point of the high-strength fiber is less than a temperature that is lower by 20° C. than the melting point of the heat-and-humidity gelling resin, shrinkage is likely to occur in association with softening or melting of a resin constituting the high-strength fiber during gel processing, likely leading to occurrence of an irregular mass per unit area, thickness, pore diameter or the like of the nonwoven. As a result, the yield of the separator is reduced, or there is a possibility that a fine powder short circuit and a dendritic short circuit occur.

The resin constituting the high-strength fiber is selected from those that have the above-described properties, including polypropylene, polyethylene, ultrahigh molecular weight polyethylene, polyester, nylon, polyparaphenylene benzobisoxazole, carbon, and the like. Among these resins, the polyolefin resins are preferable because they are quite easy to handle when an ethylene-vinyl alcohol copolymer is used as the heat-and-humidity gelling resin, and a desired battery characteristic is obtained. Particularly, polypropylene is preferable in terms of fiber production, stability of electrolytic solution, cost, and the like. Also, the high-strength fiber may be in any form of a single component fiber, a composite fiber, and the like. A cross-sectional shape of the high-strength fiber is not limited to a circle, a hollow shape, an irregular shape, an ellipse, a star, a flat shape, and the like. Taking the ease of fiber production into consideration, the cross-sectional shape is preferably a circle. When the high-strength fiber is a composite fiber, the cross-sectional shape may be of any of a concentric sheath-core type, an eccentric sheath-core type, a side-by-side type, an islands-in-the-sea type, a splittable type, and the like.

The proportion of the nonwoven occupied by the high-strength fiber is preferably in a range of 5 to 250 parts by mass where the heat-and-humidity gelling resin is assumed to be 100 parts by mass. A more preferable lower limit of the added amount is 10 parts by mass. An even more preferable lower limit of the added amount is 20 parts by mass. A more preferable upper limit of the added amount is 220 parts by mass. An even more preferable upper limit of the added amount is 200 parts by mass. When the added amount of the high-strength fiber is less than 5 parts by mass, it is difficult for the high-strength fiber to contribute to an improvement in the puncture strength, likely leading to the occurrence of a dendritic short circuit. When the added amount of the high-strength fiber exceeds 250 parts by mass, the proportion occupied by the heat-and-humidity gelling resin is small. In this case, it is difficult to obtain a small pore diameter, likely leading to occurrence of a fine powder short circuit.

Also in the organic electrolyte battery separator of the present invention, the gel material is used to fix the fiber constituting the nonwoven. Therefore, no heat-melting fiber that does not become a gel under heat and humidity has to be additionally contained. Alternatively, such a heat-melting fiber may be added for the purpose of simplification of a nonwoven production step, an improvement in the tensile strength of the nonwoven, or the like. When a heat-melting fiber is added, a preferable added amount thereof is in a range of 10 to 300 parts by mass where the amount of the heat-and-humidity gelling resin is assumed to be 100 parts by mass. A more preferable lower limit of the added amount is 20 parts by mass. An even more preferable lower limit of the added amount is 30 parts by mass. A more preferable upper limit of the added amount is 250 parts by mass. An even more preferable upper limit of the added amount is 200 parts by mass. When the added amount of the heat-melting fiber is less than 10 parts by mass, it is difficult to observe an effect of addition. On the other hand, when the added amount of the heat-melting fiber exceeds 300 parts by mass, the proportion occupied by the heat-and-humidity gelling resin is small, whereby it is difficult to reduce the pore diameter of the nonwoven, likely leading to the occurrence of a fine powder short circuit.

The heat-melting fiber refers to a fiber that does not become a gel and melts around its melting point (melting peak temperature) in the presence of moisture to bond fibers. The heat-melting fiber is distinguished from the heat-and-humidity gelling resin. Also, the heat-melting fiber is preferably a fiber that does not substantially shrink at a temperature that causes the heat-and-humidity gelling resin to become a gel (gel material) (hereinafter the temperature is referred to as a gel processing temperature). As used herein, the term “does not substantially shrink” in relation to a fiber indicates that an area shrinkage rate of the nonwoven during gel processing is less than 5%. A reason why the heat-melting fiber is defined as described above is that when a nonwoven sheet containing moisture is subjected to gel processing where the temperature of the heat treatment device is set to be 100° C. or more, the actual temperature is likely to be lower than the set temperature and it may be difficult to accurately measure the actual temperature (gel processing temperature). Therefore, it is distinguished from the gel processing temperature, and the heat-melting fiber is assumed not to substantially shrink at the gel processing temperature.

The resin used in the heat-melting fiber is not particularly limited. A polyolefin resin is preferable in terms of stability relative to the electrolytic solution. The heat-melting fiber is in the form of a single component fiber, a composite fiber, or the like. Particularly, a sheath-core composite fiber in which the sheath is made of a low-melting point resin and the core is made of a resin having a higher melting point than that of the sheath resin, is preferable. Examples of the sheath-core composite fiber include polypropylene/polyethylene, polypropylene/ethylene-propylene copolymer, polypropylene/ethylene-methyl acrylate copolymer, polypropylene/ethylene-vinyl acetate copolymer, and the like. A preferable ratio of the core resin to the sheath resin is about 30:70 to 70:30 (=core resin:sheath resin) (by volume). A fiber cross-sectional shape of the sheath-core composite fiber may be of any of a concentric sheath-core type, an eccentric sheath-core type, a side-by-side type, an islands-in-the-sea type, and the like. The concentric sheath-core type is particularly preferable.

Specifically, the nonwoven of the present invention comprises the following component fibers: a splittable composite fiber that contains the heat-and-humidity gelling resin and another resin, which are adjacent to each other in a cross-section of the fiber, to be able to provide the heat-and-humidity gelling fiber; and other fibers that are a high-strength fiber having a single fiber strength of 4.5 cN/dtex or more and a heat-melting fiber that does not substantially shrink at a temperature that causes the heat-and-humidity gelling resin under heat and humidity to gel and fix the other fibers, where, assuming that the splittable composite fiber is 100 parts by mass, the high-strength fiber is in a range of 10 to 200 parts by mass and the heat-melting fiber is in a range of 10 to 200 parts by mass. In this case, a desired battery characteristic can be most effectively obtained. A more preferable range is such that, assuming that the splittable composite fiber is 100 parts by mass, the high-strength fiber is in a range of 12.5 to 75 parts by mass and the heat-melting fiber is in a range of 12.5 to 100 parts by mass.

The nonwoven of the present invention further may comprise a fiber in addition to the above-described fibers. Also in this case, the fiber may be in any form of a single component fiber, a composite fiber, and the like. A cross-sectional shape thereof may be any of a circle, a hollow shape, an irregular shape, an ellipse, a star, a flat shape, and the like. The cross-sectional shape is preferably a circle in terms of ease of fiber production. In the case of the composite fiber form, the fiber may be of any of a concentric sheath-core type, an eccentric sheath-core type, a side-by-side type, an islands-in-the-sea type, a splittable type, and the like. The fiber may be made of any resin. Polyolefins are preferable in terms of stability of electrolytic solution.

Further, the fiber optionally may be supplemented as appropriate with an additive, such as an antioxidant, a light stabilizer, an ultraviolet absorber, a neutralizer, a nucleating agent, a lubricant, an antistatic agent, a pigment, a plasticizer, a hydrophilizing agent, or the like, in an amount that does not prevent the effect of the present invention.

In addition to the heat-and-humidity gelling resin or the heat-and-humidity gelling fiber and the other fiber(s) constituting the nonwoven, a synthetic pulp preferably is added in order to reduce the mean flow pore diameter and the bubble point pore diameter of the nonwoven. The synthetic pulp refers to a fiber-like material made of a so-called fibrillized, natural pulp-like synthetic resin, in which the fiber surface is divided into a number of branches. The synthetic pulp is distinguished from the other fiber of the present invention. Examples of the resin constituting the synthetic pulp include polyethylene, polypropylene, and the like. The average fiber length of the synthetic pulp is preferably in a range of 0.5 mm to 2 mm. The average fiber length of the synthetic pulp is used as an index for indicating a form of the synthetic pulp. Assuming that the nonwoven sheet is produced using a wetlaying technique, when the average fiber length is less than 0.5 mm, there is a possibility that a larger amount of the synthetic pulp drops out in a wetlaying step. When the average fiber length exceeds 2 mm, there is a possibility that the dispersion ability is lowered during a wetlaying process. An example of a synthetic pulp that satisfies the above-described conditions, includes “SWP” EST-8, E400 (tradename, manufactured by Mitsui Chemicals, Inc.) and the like.

Assuming the heat-and-humidity gelling resin is 100 parts by mass in the nonwoven, the synthetic pulp is preferably in a range of 10 to 200 parts by mass. A more preferable lower limit of the added amount is 20 parts by mass. A more preferable upper limit of the added amount is 150 parts by mass. When the added amount of the synthetic pulp is less than 10 parts by mass, it is difficult to observe an effect from the addition. On the other hand, when the added amount of the synthetic pulp exceeds 200 parts by mass, the proportion of the heat-and-humidity gelling resin is decreased, and therefore, there is a possibility that the puncture strength is reduced.

Specifically, the nonwoven comprises the following component fibers: a splittable composite fiber that contains the heat-and-humidity gelling resin and another resin, which are adjacent to each other in a cross-section of the fiber, to be able to provide the heat-and-humidity gelling fiber; and other fibers that are the above-described high-strength fiber and a heat-melting fiber that does not substantially shrink at a temperature that causes the heat-and-humidity gelling resin under heat and humidity to gel and fix the other fibers, where, assuming that the splittable composite fiber is 100 parts by mass, the high-strength fiber is in a range of 6.25 to 120 parts by mass and the heat-melting fiber is in a range of 12.5 to 120 parts by mass; and in addition, the above-described synthetic pulp that is in a range of 6.25 to 120 parts by mass. In this case, a desired battery characteristic can be obtained most effectively and the thickness can be reduced most effectively. More preferably, assuming that the splittable composite fiber is 100 parts by mass, the high-strength fiber is in a range of 7 to 100 parts by mass, the heat-melting fiber is 15 to 115 parts by mass, and the synthetic pulp is 15 to 100 parts by mass.

The organic electrolyte battery separator of the present invention needs to have a mean flow pore diameter in a range of 0.3 μm to 5 μm, and a bubble point pore diameter in a range of 3 μm to 20 μm. A more preferable lower limit of the mean flow pore diameter is 0.4 μm. An even more preferable lower limit of the mean flow pore diameter is 0.5 μm. A more preferable upper limit of the mean flow pore diameter is 4.5 μm. An even more preferable upper limit of the mean flow pore diameter is 4 μm. On the other hand, a more preferable lower limit of the bubble point pore diameter is 4 μm. An even more preferable lower limit of the bubble point pore diameter is 5 μm. A more preferable upper limit of the bubble point pore diameter is 15 μm. An even more preferable upper limit of the bubble point pore diameter is 13 μm. A most preferable upper limit of the bubble point pore diameter is 10 μm. By satisfying these conditions simultaneously, it is possible to obtain a separator that has an excellent level of fine powder short circuit prevention ability and dendritic short circuit prevention ability. When the mean flow pore diameter is less than 0.3 μm or the bubble point pore diameter is less than 3 μm, the electrolytic solution holding ability is deteriorated, likely leading to a large internal resistance of the battery. On the other hand, when the mean flow pore diameter exceeds 5 μm or the bubble point pore diameter exceeds 20 μm, a fine powder short circuit and a dendritic short circuit are likely to occur.

The organic electrolyte battery separator of the present invention preferably has a mean flow pore diameter reduction rate of 60% or more. The mean flow pore diameter reduction rate (%) is represented by:
mean flow pore diameter reduction rate (%)={(X−X_{B})/X}×100
where X_{B} represents a mean flow pore diameter of the nonwoven after gel processing of the heat-and-humidity gelling resin and X represents a mean flow pore diameter of the nonwoven sheet before gel processing.

The mean flow pore diameter reduction rate is an index for indicating how much the heat-and-humidity gelling resin is pressed and spread to form a gel material when the nonwoven sheet (starting material before gel processing) containing the heat-and-humidity gelling resin is subjected to gel processing, i.e., an index for indicating a degree of gelation. A more preferable lower limit of the mean flow pore diameter reduction rate is 70%. A preferable upper limit of the mean flow pore diameter reduction rate is 95%. When the mean flow pore diameter reduction rate is less than 60%, the heat-and-humidity gelling resin does not substantially uniformly become a gel, whereby there is a possibility that a desired puncture strength is not obtained. When the mean flow pore diameter reduction rate exceeds 95%, a gap of the separator is small. As a result, the electrolytic solution permeability is lowered, whereby there is a possibility that the internal resistance of the battery is increased.

In the organic electrolyte battery separator of the present invention, the heat-and-humidity gelling resin is pressed and spread while gelling under heat and humidity, and the gel material fills a gap between fibers constituting the nonwoven to fix the other fiber. In this case, the gel material preferably is formed into a film that partially covers a surface of the nonwoven. The proportion of the entire surface of the nonwoven occupied by the film (film degree) is preferably in a range of 40% to 90%. A more preferable lower limit of the film degree is 45%. An even more preferable lower limit of the film degree is 50%. A preferable upper limit of the film degree is 80%. An even more preferable upper limit of the film degree is 70%. The film degree is an index for indicating a degree of spread of the gel material, i.e., an index for indicating a degree of penetration between fibers. A larger film degree indicates that the gel material is substantially uniformly spread on a surface and an inside of the nonwoven. When the film degree is less than 40%, penetration of the gel material between fibers is insufficient. In this case, it is difficult to obtain an appropriate mean flow pore diameter range and bubble point pore diameter range, and particularly the bubble point pore diameter is likely to be large. As a result, a fine powder short circuit is likely to occur. On the other hand, when the film degree exceeds 90%, a region in which the film covers the nonwoven to remove pores is likely to be increased. As a result, the electrolytic solution permeability is deteriorated, whereby there is a possibility that the internal resistance of the battery is increased.

Particularly, in order to obtain a separator having an appropriate mean flow pore diameter range and bubble point pore diameter range as in the present invention, it is important to cause the heat-and-humidity gelling resin existing throughout the nonwoven sheet to gel more uniformly during gel processing. To achieve this, it is important to uniformly provide moisture into the entire nonwoven sheet including its inside before gel processing. In other words, it is important for the nonwoven sheet to have water wettability more uniformly. An example of an index for indicating the water wettability is a contact angle of dechlorinated water. The smaller the contact angle, the higher the water wettability, i.e., moisture can be provided more uniformly to the nonwoven sheet. Specifically, the contact angle of the dechlorinated water on the nonwoven sheet surface before gel processing is preferably 60 degrees or less five seconds after dropping of the dechlorinated water. A more preferable contact angle is 55 degrees or less. An even more preferable contact angle is 50 degrees or less. When the contact angle of the dechlorinated water on the nonwoven sheet surface exceeds 60 degrees, the water wettability is likely to be insufficient, so that it is difficult to provide moisture uniformly.

When a hydrophobic fiber, such as a polyolefin resin, is used in the separator of the present invention, it is likely that the water wettability is insufficient and it is difficult to provide moisture uniformly. Therefore, it is preferable to subject the nonwoven sheet to a hydrophilic treatment. Examples of the hydrophilic treatment include a corona discharge treatment, a plasma treatment, an electron beam treatment, a treatment of exposure to fluorine atmosphere (hereinafter referred to as a fluorine treatment), a graft treatment, a sulfonation treatment, a surfactant treatment, and the like.

For example, in the case of the corona discharge treatment, both sides of the nonwoven sheet each are treated 1 to 20 times, where a total discharge amount is in a range of 0.05 to 10 k W·min/m². In the case of the fluorine treatment, for example, a hydrophilic group is introduced into the nonwoven sheet by contacting with a gas mixture of fluorine gas diluted with inert gas, and oxygen gas or sulfur dioxide gas. In the case of the graft polymerization treatment, the nonwoven sheet is immersed in a solution containing a vinyl monomer and a polymerization initiator, followed by heating, or a vinyl monomer is applied onto the nonwoven sheet before applying radiation. More preferably, by modifying the quality of the nonwoven sheet surface using ultraviolet irradiation, corona discharge, plasma discharge, or the like before contacting the vinyl monomer solution and the nonwoven sheet, graft polymerization can be performed efficiently. Examples of the sulfonation treatment include a concentrated sulfuric acid treatment, a fuming sulfuric acid treatment, a chlorosulfuric acid treatment, an anhydrous sulfuric acid treatment, and the like. In the case of the surfactant treatment, the nonwoven sheet is immersed in a solution of a hydrophilic anion surfactant or a nonion surfactant, or the surfactant is attached to the nonwoven sheet by application, for example. Note that the above-described hydrophilic treatment may be applied to the nonwoven after gel processing. Any two or more of the above-described treatment methods may be combined.

Among the hydrophilic treatments, the fluorine treatment is particularly preferable since moisture can be provided more uniformly up to the inside of the nonwoven sheet during gel processing. Further, the fluorine treatment can introduce a hydrophilic group deeper from the resin surface, so that a reduction in hydrophilicity is small after gel processing, i.e., the hydrophilicity of the nonwoven can be maintained after gel processing. As a specific condition of the fluorine treatment, the fluorine concentration of the gas mixture in the fluorine treatment is preferably in a range of 0.01 to 80 volume %. A more preferable lower limit of the fluorine concentration is 0.1 volume %. An even more preferable lower limit of the fluorine concentration is 0.5 volume %. A more preferable upper limit of the fluorine concentration is 30 volume %. An even more preferable upper limit of the fluorine concentration is 10 volume %. The reaction temperature is preferably in a range of 10° C. or more and 50° C. or less. The reaction time is preferably in a range of 1 second or more to 30 minutes, though not particularly limited.

In the organic electrolyte battery separator of the present invention, the contact angle of dechlorinated water on the nonwoven surface is preferably 60 degrees or less five seconds after dropping of the dechlorinated water. A more preferable contact angle is 55 degrees or less. A more preferable contact angle is 50 degrees or less. The contact angle serves as an index for indicating a degree of reduction in water wettability due to gel processing. A hydrophilic treatment that can maintain the contact angle at 60 degrees or less after gel processing, is preferable since moisture can be provided up to the inside of the nonwoven sheet of the present invention before gel processing. Such a hydrophilic treatment that can maintain the contact angle at 60 degrees or less after gel processing includes a fluorine treatment as described above, though any treatment having a similar effect can be used.

The organic electrolyte battery separator of the present invention preferably has a puncture strength of 2 N or more. A more preferable lower limit of the puncture strength is 2.2 N. The puncture strength is a substitute characteristic for indicating the level of dendritic short circuit prevention ability. The greater the puncture strength, the more unlikely a dendritic short circuit occurs. When the puncture strength is less than 2 N, a dendritic short circuit is likely to occur. A standard deviation of the puncture strength is preferably 1.1 N or less, more preferably 1 N or less, and even more preferably 0.9 N or less. The standard deviation of the puncture strength is an index for indicating a variation in the puncture strength. The greater the standard deviation of the puncture strength, the more likely a dendritic short circuit occurs since there is a portion having a small puncture strength. When the standard deviation exceeds 1.1 N, a dendritic short circuit is likely to occur as described above.

An index for indicating a variation in the puncture strength, which is calculated based on the puncture strength and the standard deviation of the nonwoven according to the following expression, is preferably 0.165 or less:
“puncture strength variation index=standard deviation/puncture strength”.

The variation index is calculated based on the standard deviation using the average of the puncture strength as a reference. The smaller the variation index value, the closer the variation index value is to the average, i.e., it is indicated that the variation is small. Such a small variation index (parameter) is achieved by causing the heat-and-humidity gelling resin to become a gel that is in turn pressed and spread and causing the resultant gel material to fix the other fiber, as in the present invention.

The organic electrolyte battery separator of the present invention preferably has a thickness in a range of 15 μm to 80 μm. A more preferable lower limit of the thickness is 20 μm. An even more preferable lower limit of the thickness is 25 μm. A more preferable upper limit of the thickness is 70 μm. An even more preferable upper limit of the thickness is 60 μm. When the thickness of the separator is less than 15 μm, a pore diameter of the separator, particularly a bubble point pore diameter thereof, is likely to be increased, whereby there is a possibility that the fine powder short circuit prevention ability and the dendritic short circuit prevention ability are reduced. On the other hand, when the thickness of the separator exceeds 80 μm, the electrolytic solution permeability is deteriorated, so that there is a possibility that the internal resistance of the battery is increased. Further, the number of electrodes per volume of the battery is reduced, likely leading to poor battery performance.

A specific volume of the nonwoven in the organic electrolyte battery separator of the present invention is preferably in a range of 1.2 cm³/g to and 2.5 cm³/g. A more preferable lower limit of the specific volume is 1.3 cm³/g. An even more preferable lower limit of the specific volume is 1.4 cm³/g. A more preferable upper limit of the specific volume is 2.3 cm³/g. An even more preferable upper limit of the specific volume is 2.1 cm³/g. When the specific volume is less than 1.2 cm³/g, the nonwoven is excessively dense, so that the electrolytic solution holding ability is poor. As a result, there is a possibility that the internal resistance of the battery is increased. On the other hand, when the specific volume exceeds 2.5 cm³/g, the size of the nonwoven is excessively large, so that it is difficult to obtain a small pore diameter in the separator. As a result, a fine powder short circuit is likely to occur.

An mass per unit area of the nonwoven in the organic electrolyte battery separator of the present invention is preferably in a range of 10 to 50 g/m². A more preferable lower limit of the mass per unit area of the nonwoven is 15 g/m². An even more preferable lower limit of the mass per unit area of the nonwoven is 20 g/m². A more preferable upper limit of the mass per unit area of the nonwoven is 45 g/m². An even more preferable upper limit of the mass per unit area of the nonwoven is 40 g/m². When the mass per unit area of the nonwoven is deviated from the above-described range, it is difficult to obtain an intended separator thickness and pore diameter.

Next, the organic electrolyte battery separator of the present invention will be described while indicating a production method thereof. Firstly, when the heat-and-humidity gelling resin is in the form of a fiber, a heat-and-humidity gelling fiber and other fiber(s) are prepared, and a nonwoven sheet is produced using a known technique. The average fiber diameter of the nonwoven sheet is preferably 10 μm or less. The reason is described above.

Next, the nonwoven sheet optionally can be caused to be a hydrophilic nonwoven sheet by the above-described hydrophilic treatment. By providing moisture to the nonwoven sheet or the hydrophilic nonwoven sheet, a water-containing sheet is produced. In order to obtain the separator of the present invention, it is not necessary to cause the heat-and-humidity gelling resin to absorb up to an inside thereof. Moisture only needs to be attached around the heat-and-humidity gelling resin. By sandwiching the thus-constructed water-containing sheet between heating bodies with a method as described below, vapor that instantaneously occurs is confined in the nonwoven sheet by the heating bodies, so that the heat-and-humidity gelling resin can be caused to instantaneously gel inward as far as an inside of the nonwoven sheet.

A proportion of moisture provided to the hydrophilic nonwoven sheet is preferably in a range of 20 to 300 mass %. A more preferable lower limit of the moisture proportion is 30 mass %. An even more preferable lower limit of the moisture proportion is 40 mass %. A more preferable upper limit of the moisture proportion is 200 mass %. An even more preferable upper limit of the moisture proportion is 150 mass %. When the moisture proportion is less than 20 mass %, gelation of the heat-and-humidity gelling fiber is not sufficient, so that it is likely to be difficult to cause the gel material to penetrate between component fibers. As a result, there is a possibility that the heat-and-humidity gelling fiber has difficulty in contributing to obtaining an appropriate mean flow pore diameter range and bubble point pore diameter range. On the other hand, when the moisture proportion exceeds 300 mass %, it is unlikely that heat is applied uniformly to the surface and inside of the nonwoven sheet during gel processing, so that there is a possibility that only the nonwoven surface becomes a film. As a result, the degree of gelation in a thickness direction of the resultant separator is not uniform, so that fixation of the other component fiber(s) is not uniform. As a result, there is a possibility that the irregularity of a pore diameter in the thickness direction is large. Moisture may be applied by any of spraying, dipping into a water tank, and the like.

The water-containing sheet is subjected to a heat-and-humidity treatment (gel processing) using a heat treatment device that is set to be at a temperature in a range of no less than a temperature that causes the heat-and-humidity gelling resin to gel and no more than “the melting point of the heat-and-humidity gelling resin −20° C.”. As a result, the heat-and-humidity gelling resin becomes a gel and the resultant heat-and-humidity gelling resin gel fixes the other fiber, thereby obtaining an organic electrolyte battery separator. The set temperature during gel processing is preferably at least 60° C. and not more than “the melting point of the heat-and-humidity gelling resin −20° C.”. A more preferable lower limit of the set temperature is 80° C. An even more preferable lower limit of the set temperature is 85° C. A more preferable upper limit of the set temperature is 140° C. An even more preferable upper limit of the set temperature is 135° C. When the set temperature of gel processing is less than 80° C., it is difficult to obtain sufficient gelation. In this case, fixation of the other component fiber is not sufficient, or there is a possibility that it is difficult to obtain an appropriate mean flow pore diameter range and bubble point pore diameter range. On the other hand, when the set temperature of gel processing exceeds “the melting point of the heat-and-humidity gelling resin −20° C.”, if a thermal roller is used during gel processing, the heat-and-humidity gelling resin is likely to adhere to the roller, or the nonwoven shrinks, resulting in a deterioration in the dimension stability or the like. Therefore, the yield is likely to be lowered and the battery defect rate is likely to be increased. A reason why the temperature of gel processing is regarded as the set temperature is as follows. When the water-containing nonwoven sheet is subjected to gel processing, moisture in the nonwoven sheet firstly is evaporated where the temperature of the heat treatment device is set to be 100° C. or more. In this case, the heat-and-humidity gelling resin proceeds with gelling, so that an actual temperature of gel processing is likely to be lower than the set temperature. Therefore, it may be difficult to exactly determine the gel processing temperature. Therefore, even when the melting point of the other fiber is lower than the set temperature of the heat treatment device, the other fiber may not be substantially melted or may not be substantially shrunk. Therefore, the gel processing temperature is preferably a temperature that does not cause the other fiber to substantially shrink.

The gel processing is preferably pressure processing using a thermal roller, a thermal press or the like. According to press processing, when the heat-and-humidity gelling resin is caused to gel under heat and humidity, the gel material is pressed and spread to penetrate readily between fibers, so that an appropriate mean flow pore diameter and bubble point pore diameter can be obtained. Particularly, the press processing is more preferably performed using a thermal roller because of an excellent level of productivity.

The thermal roller preferably has a line pressure in a range of 350 to 10000 N/cm. A more preferable lower limit of the line pressure is 400 N/cm. A more preferable upper limit of the line pressure is 9000 N/cm. When the line pressure is less than 350 N/cm, it is difficult to cause the heat-and-humidity gelling resin to penetrate sufficiently to the inside of the nonwoven, and also, it is difficult to cause the gel material on the nonwoven surface to become a film. As a result, it is difficult for the heat-and-humidity gelling resin to contribute to obtaining of an appropriate mean flow pore diameter range and bubble point pore diameter range, likely leading to the occurrence of a fine powder short circuit. On the other hand, when the line pressure exceeds 10000 N/cm, the pressure is excessively high, so that the fiber is likely to be cut and a through-hole is likely to occur. As a result, a fine powder short circuit is likely to occur, or there is a possibility that the puncture strength of the separator is lowered. When the heat-and-humidity gelling resin adheres to the thermal roller during gel processing, a release agent, such as a surfactant or the like, may be optionally employed, for example. Further, an oiling agent, a sizing agent or the like may be added in an amount such that the nonwoven after gel processing does not lose the effect of the present invention.

On the other hand, the heat-and-humidity gelling resin may be in the form of powder, emulsion or the like other than fiber. In this case, the heat-and-humidity gelling resin can be, for example, attached to the nonwoven sheet when the nonwoven sheet, which has been prepared, is caused to be a water-containing sheet.

Further, a specific exemplary method of producing the organic electrolyte battery separator of the present invention will be described. Initially, the heat-and-humidity gelling fiber and other fiber(s) are prepared. A nonwoven sheet having an average fiber diameter of 10 μm or less is produced using a known technique. Examples of the form of the nonwoven sheet include a drylaid web or a drylaid nonwoven obtained by, representatively, a carding method or an air-laying method, and a wetlaid web or a wetlaid nonwoven obtained by a wetlaying method. To obtain a more uniform nonwoven, a wetlaid web or a wetlaid nonwoven (hereinafter referred to as a wetlaid nonwoven sheet) obtained by a wetlaying method is preferable.

A fiber length of a fiber for use in the wetlaid nonwoven sheet is preferably in a range of 1 mm to 20 mm. A more preferable lower limit of the fiber length is 2 mm. An even more preferable lower limit of the fiber length is 3 mm. A more preferable upper limit of the fiber length is 15 mm. An even more preferable upper limit of the fiber length is 12 mm. When the fiber length is less than 1 mm, the puncture strength is poor. As a result, a dendritic short circuit is likely to occur. When the fiber length exceeds 20 mm, the dispersion ability of the fiber in slurry is deteriorated, so that it is difficult to obtain a nonwoven having uniform texture. As a result, a large bubble point pore diameter is particularly likely to occur, likely leading to the occurrence of a fine powder short circuit.

In the case of the wetlaid nonwoven sheet, an ordinary method may be used. Each fiber is mixed to a desired range, and is dispersed in water to a concentration of 0.01 to 0.6 mass %, to adjust a slurry. In this case, a small amount of dispersing agent may be added. When a splittable composite fiber is used as a fiber constituting the slurry, the fiber is split during beating and disintegration of the slurry. In this case, the splittable fiber is more uniformly dispersed in the nonwoven during a wetlaying process, so that the gel material is substantially uniformly pressed and spread during gel processing. As a result, it is possible to obtain a denser separator with an appropriate mean flow pore diameter and bubble point pore diameter and a small variation in the puncture strength. Particularly, when a splittable composite fiber having the heat-and-humidity gelling resin is used and the fiber is split during beating and disintegration of the slurry, the heat-and-humidity gelling fiber that has been changed to a microfine fiber can be dispersed in the nonwoven more uniformly during the wetlaying process. As a result, when the heat-and-humidity gelling fiber is caused to become a gel, the gel is pressed and spread to penetrate between fibers and the gel material fixes the component fiber substantially uniformly. Thereby, the mean flow pore diameter and the bubble point pore diameter are caused to be more appropriate, so that a separator having a large puncture strength and a small variation in puncture strength is likely to be obtained. As a result, it is possible to obtain a separator that has an excellent level of fine powder short circuit prevention ability and dendritic short circuit prevention ability. The slurry is caused to have a desired mass per unit area using a papermaking machine of a short wire type, a cylinder type, a fourdrinier type, or a combination thereof.

The web or the nonwoven may be subjected to a hydroentangling process to an extent such that the effect of the present invention is not prevented. When a splittable composite fiber is used as a component fiber, the hydroentangling process promotes the splittable composite fiber to be split, so that the degree of entanglement between fibers is increased.

Next, the wetlaid nonwoven sheet is subjected to the hydrophilic treatment to produce a hydrophilic nonwoven sheet. Moisture is provided to the hydrophilic nonwoven sheet to a moisture proportion in a range of 20 to 300 mass %, resulting in a water-containing sheet. Thereafter, the water-containing sheet is subjected to gel processing using a thermal roller that is heated to at least 60° C. and not more than a temperature of “the melting point of the heat-and-humidity gelling resin −20° C.” under a line pressure of 350 to 10000 N/cm. With the above-described process, it is preferably possible to obtain an appropriate mean flow pore diameter range and bubble point pore diameter range of the separator and achieve a small variation in the puncture strength.

Note that the nonwoven for use in the present invention may be used singly, or alternatively, optionally may be laminated with another sheet, such as, for example, a fine-porous film, other nonwovens, or the like.

In the organic electrolyte battery separator of the present invention, a resin capable of gelling by being heated in the presence of moisture is caused to gel under heat and humidity and the resultant gel material is used to fix other fiber(s) constituting the nonwoven, thereby making it possible to obtain a desired mean flow pore diameter and bubble point pore diameter. As a result, it is possible to obtain an organic electrolyte battery having an excellent level of safety, less frequent short circuits, and an excellent battery characteristic. Further, with the above-described structure, the nonwoven has substantially no shrinkage, i.e., substantially no change in a dimension of the nonwoven, when subjected to thermal processing. Therefore, it is possible to obtain a separator in which an appropriate mean flow pore diameter range and bubble point pore diameter range can be obtained, the puncture strength is large, and a variation in the puncture strength is small. Further, it is possible to provide an inexpensive organic electrolyte battery separator in which the yield is excellent, the battery defect rate is low, and particularly, the short circuit prevention ability is excellent.

The organic electrolyte battery separator of the present invention is produced by a method in which the nonwoven sheet containing the heat-and-humidity gelling resin and other fiber(s) is impregnated with water and is subjected to gel processing at a temperature range of no less than a temperature that causes the heat-and-humidity gelling resin to gel and no more than “the melting point of the heat-and-humidity gelling resin −20° C.”. As a result, a separator that achieves a desired mean flow pore diameter and bubble point pore diameter can be obtained. By subjecting the nonwoven sheet containing the heat-and-humidity gelling resin and the other fiber to a hydrophilic treatment before gel processing, the entire nonwoven sheet can hold moisture uniformly, leading to uniform gelation of the heat-and-humidity gelling resin. Further, when thermal press processing is employed as gel processing, the substantially uniformly-dispersed heat-and-humidity gelling resin is caused to become a gel, which is in turn pressed and spread, and the resultant gel material can fix the other component fiber inward to the inside of the nonwoven substantially uniformly.

### EXAMPLES

Hereinafter, the present invention will be specifically described by way of examples. Note that the melting point, the single fiber fineness, the single fiber strength, the thickness, the puncture strength, the standard deviation of puncture strengths, the mean flow pore diameter, the bubble point pore diameter, the film degree of nonwoven surface, the contact angle of the nonwoven, and the area shrinkage ratio of the nonwoven (hereinafter referred to as “processing shrinkage ratio”) were measured by the following techniques:

(1) Melting point: measured in accordance with JIS K 7121 (DSC method).

(2) Single fiber fineness: measured in accordance with JIS L 1013.

(3) Single fiber strength: measured in accordance with JIS L 1015; a tensile tester was used to measure the value of the load at which a fiber is broken where a length between clamps of the sample was 20 mm, and the single fiber strength is represented by the load value.

(4) Thickness: thicknesses were measured at 10 different points for each of three samples under a load of 175 kpa (measured using a micrometer in accordance with JIS-B-7502) and the average value of a total of the 30 points was calculated.

(5) Puncture strength: a nonwoven was cut out into a size of 30 mm (length)×100 mm (width); on the sample thus prepared, an aluminum press plate (length: 46 mm, width: 86 mm, thickness: 7 mm) having a 11 mm-diameter hole in its middle was placed; a peak load (N) was measured when a needle was caused to pierce the middle hole of the press plate vertically with a speed of 2 mm/sec, where the needle is in the shape of a cone 18.7 mm in height with a ball-shaped tip portion of 1 mm diameter and a shaft having a base diameter of 2.2 mm, and a “KES-G5 Handy Compression Tester” manufactured by Kato Tech Co., Ltd. was used; and the puncture strength is represented by the peak load. Note that puncture strengths were measured at 15 different points of each of four samples and the average value of all 60 points was calculated.

(6) Standard deviation of puncture strengths: a standard deviation of the above-described puncture strengths was calculated where n=60.

(7) Mean flow pore diameter•bubble point pore diameter: measured by the bubble point method using a permporometer (manufactured by Porous Materials Inc.) in accordance with ASTM F 316 86.

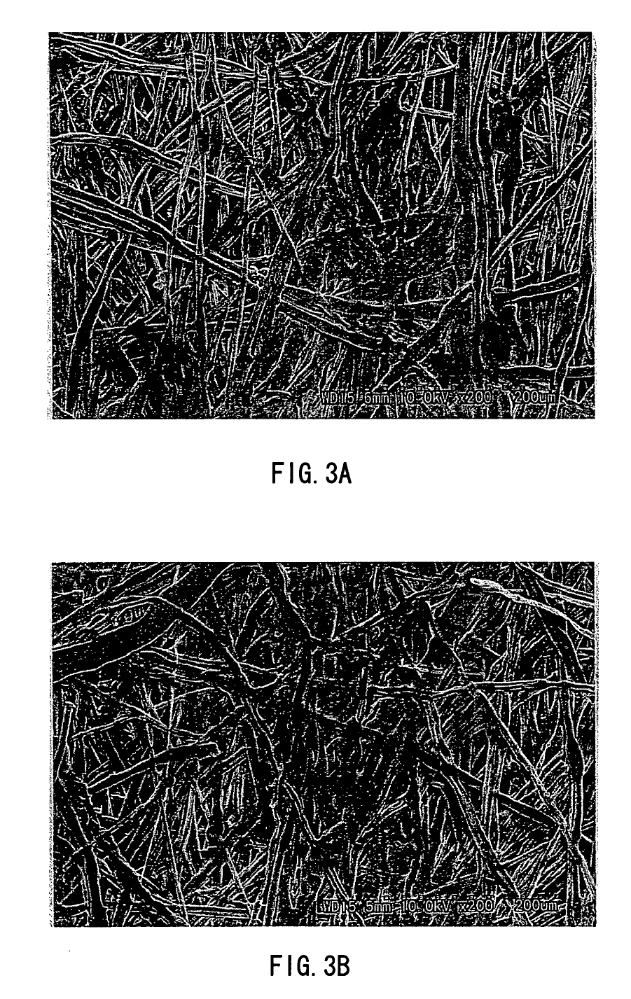

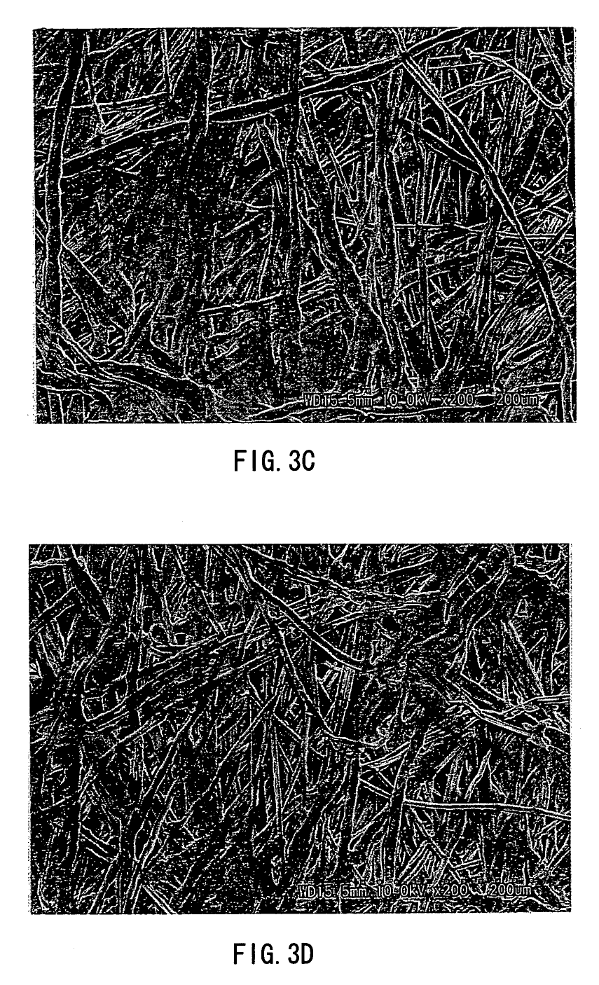

(8) Film degree of nonwoven surface: a surface of a nonwoven is photographed using an electronic microscope at 200× magnification on 10 arbitrary points. For example, as shown in FIGS. 3A to 3D, the percentage of the area of adjacent fibers continuously fixed on the nonwoven surface was calculated with respect to the entire area of the nonwoven.

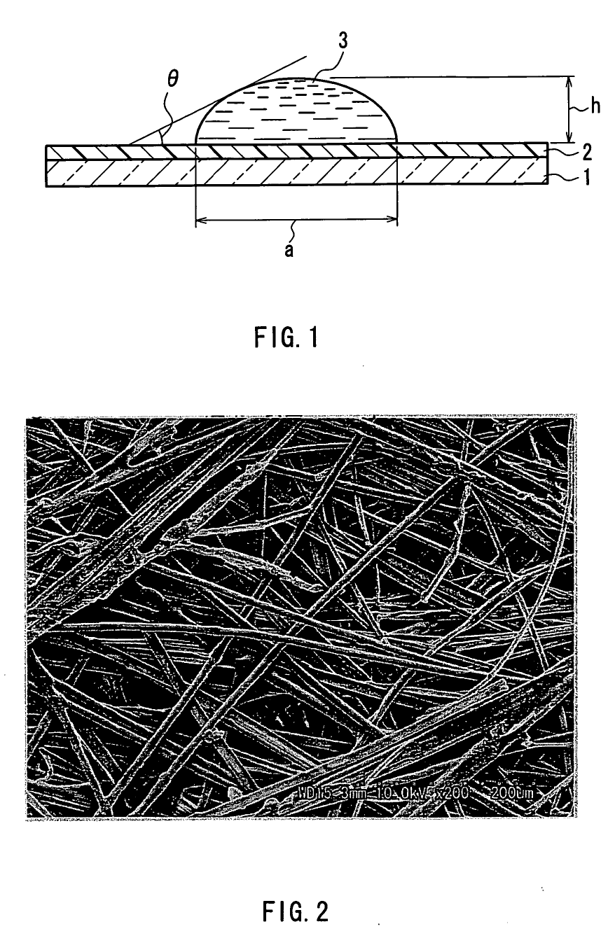

(9) Contact angle of nonwoven sheet surface: a contact angle meter (cleanliness evaluation system, type CA-X150, manufactured by Kyowa Interface Science Co., Ltd.) is used. As shown in FIG. 1, a sample 2 of 1 cm (length)×5 cm (width) is placed and fixed to a glass plate 1 with a tape. Next, 2 microliters of pure water 3 are precisely dropped onto the sample 2 using a microsyringe. After being allowed to stand for 5 seconds, a diameter a and a height h of the water drop of FIG. 1 are measured. The contact angle θ is calculated based on the diameter a and the height h using the following expression:
tan(θ/2)=h/(a/2).

(10) Processing shrinkage ratio (%): calculated using the following expression:
{1−(post-gel processing nonwoven area/pre-gel processing nonwoven sheet area)}×100.

(11) Battery characteristics

Short Circuit Characteristics

Eighty separators were laminated and incorporated between the positive and negative electrodes of an E6 battery (15 cm×15 cm, rectangular type), thereby producing a lithium ion secondary battery. Before injection of electrolytic solution, when a mega electrical resistance meter did not display ∞, it was determined that there is a short circuit, or when ∞ was displayed, it was determined that there was no short circuit.

Safety

Eighty separators were laminated and incorporated between the positive and negative electrodes of an E6 battery (15 cm×15 cm, rectangular type), thereby producing a lithium ion secondary battery having an electric capacity of 39.11 Ah (when discharging a 0.5-C constant current). Initially, charging was started under conditions such that the charging current was 10 A and the set upper voltage limit was 20 V. Generation of gas in the battery and damage of the battery pack were observed and evaluated when overcharging.

Self-Discharge Amount

Eighty separators were laminated and incorporated between the positive and negative electrodes of an E6 battery (15 cm×15 cm, rectangular type), thereby producing a lithium ion secondary battery.

The resultant battery was charged to a predetermined voltage (starting voltage). Thereafter, the battery was allowed to stand in a 25° C. constant temperature bath for four weeks. After four weeks, the voltage was measured. A difference between the starting voltage and the voltage after four weeks was defined as a self-discharge amount.

Electric Capacity•Output Characteristics

Eighty separators were laminated and incorporated between the positive and negative electrodes of an E6 battery (15 cm×15 cm, rectangular type), thereby producing a lithium ion secondary battery having an electric capacity of 42.41 Ah (when charging/discharging a 0.5-C constant current/constant voltage). Electric capacities that were obtained when charging/discharing 1.0-C, 4.0-C or 6.0-C constant current/constant voltage, and the proportion of an electric capacity obtained at each rated capacity where 42.41 Ah is regarded as 100%, were obtained (output characteristics). When the output characteristic was 80% or more at 6.0 C, the battery was accepted.

Fiber materials used in the examples and comparative examples were prepared as follows.

Fiber 1

A first component was a heat-and-humidity gelling resin that was an ethylene-vinyl alcohol copolymer having an ethylene content of 38 mol % and a saponification degree of 99% (EVOH, Soarnol K3835BN, melting point 170° C., manufactured by The Nippon Synthetic Chemical Industry Co., Ltd.). A second component was polypropylene (PP, SA03B, melting point 163° C., manufactured by Japan Polychem Corporation). These components were melted and formed into a fiber using a known technique, and the fiber was stretched by a factor of three in air at 150° C., so that a splittable composite fiber was prepared that had a 16-radially segmented cross-sectional shape, a first component/second component area ratio of 50/50, and a fiber length of 6 mm.

Fiber 2

A first component was high-density polyethylene (HDPE, HE490, melting point 132° C., manufactured by Japan Polychem Corporation). A second component was polypropylene (SA03B, melting point 163° C., manufactured by Japan Polychem Corporation). These components were melted and formed into a fiber using a known technique, and the fiber was stretched by a factor of five in hot water of 90° C., so that a splittable composite fiber was prepared that had a 16-radially segmented cross-sectional shape, a first component/second component area ratio of 50/50, and a fiber length of 6 mm.

Fiber 3

A sheath component was high-density polyethylene (HE490, melting point 132° C., manufactured by Japan Polychem Corporation). A core component was polypropylene (SA03B, melting point 163° C., manufactured by Japan Polychem Corporation). These components were melted and formed into a fiber using a known technique, and the fiber was stretched by a factor of four in hot water of 90° C., so that a concentric sheath-core composite fiber was prepared that had a core component/sheath component area ratio of 50/50 and a fiber length of 10 mm.

Fiber 4

A polypropylene (SA03B, melting point 163° C., manufactured by Japan Polychem Corporation) was melted and formed into a fiber, and the fiber was stretched by a factor of three in air of 150° C. so that a circular-cross-sectional polypropylene single component fiber was prepared that had a single fiber strength of 5.8 cN/dtex and a fiber length of 10 mm.

Synthetic Pulp

As a synthetic pulp, a polyethylene synthetic pulp (trade name: SWP EST-8, manufactured by Mitsui Chemicals, Inc.) was prepared.

### Example 1

50 mass % of the fiber 1 having a fineness of 1.4 dtex (post-split minor-axis thicknesses: 2.57 μm (PP), 2.66 μm (EVOH)), 30 mass % of the fiber 3 of 0.8 dtex (fiber diameter: 10.3 μm), and 20 mass % of the fiber 4 of 0.6 dtex (fiber diameter: 8.37 μm) were mixed to prepare a water-dispersed slurry to a concentration of 0.5 mass %. From the water-dispersed slurry thus obtained, wetlaid webs having an mass per unit area of 15 g/m² was produced using a cylinder type wet papermaking machine and a short wire type wet papermaking machine. The two webs were combined together. Next, a thermal treatment was performed at 135° C. using a cylinder dryer for drying, and at the same time, the heat-and-humidity gelling resin of the fiber 1 and the sheath component of the fiber 4 temporarily bonded the fibers. The wetlaid nonwoven sheet having an mass per unit area of 30 g/m² was rolled up. In the resultant wetlaid nonwoven sheet, substantially 100% of the fiber 1 was split and substantially uniformly dispersed in the nonwoven. Note that the split ratio was obtained as follows. The nonwovens were bundled in a manner such that the bundle has a cross-section in a longitudinal direction of the nonwoven. The bundle of the nonwoven fibers was passed through a metal plate having a 1-mm diameter hole. The resultant nonwoven was magnified by a factor of 400 using an electric microscope. The proportion of splittable fibers was calculated.

Next, the wetlaid nonwoven sheet was treated at room temperature (25° C.) for one minute in a processing chamber into which a gas mixture consisting of 1 volume % of fluorine, 73 volume % of oxygen, and 26 volume % of nitrogen had been introduced. Thereafter, the sheet was washed with hot water of 60° C., followed by drying at 70° C. using a hot air dryer. Thus, a hydrophilic nonwoven sheet was obtained. On the hydrophilic nonwoven sheet thus obtained, the contact angle of dechlorinated water was 0 degrees. FIG. 2 shows a 200×SEM micrograph of a surface of the nonwoven sheet.

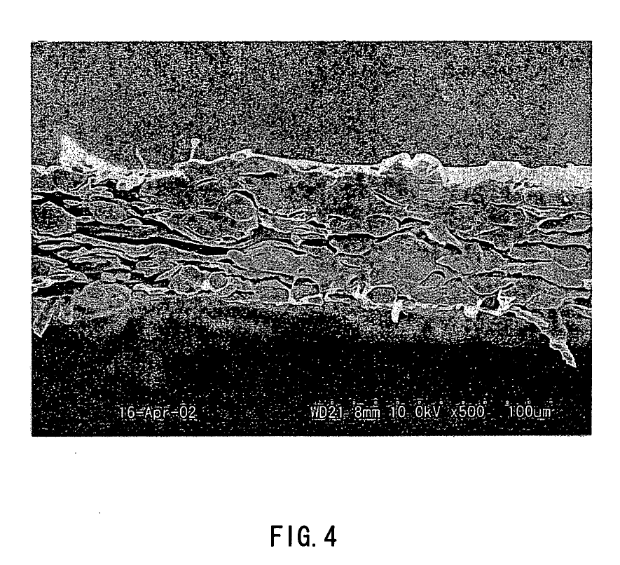

The hydrophilic nonwoven sheet was impregnated with water to 100 mass % with respect to the sheet by spraying. The sheet was subjected to gel processing using a pair of smooth rollers heated to 130° C. (a thermal roller) with a line pressure of 500 N/cm and a processing speed of 3.3 m/min. Thus, an organic electrolyte battery separator of the present invention was obtained. In the thus-obtained separator, the average fiber diameter of the pre-gel processing nonwoven sheet was 6.08 μm, while the average fiber diameter of fiber(s) other than the heat-and-humidity gelling resin was 7.22 μm. FIGS. 3A to 3D show 200×SEM micrographs of a surface of the separator. In FIG. 3A, a portion extending downward from a right side of a middle thereof, which looked like a film, was a film-like gel material. Similarly, a portion extending over a vertical direction of a middle portion in FIG. 3B, a left portion in FIG. 3C, and a left portion and an upper right portion in FIG. 3D were film-like gel materials. FIG. 4 shows a 500×SEM micrograph of a cross-section of the battery separator.

### Example 2

An organic electrolyte battery separator was obtained with a process similar to that of Example 1, except that the fiber 3 had 1.2 dtex (fiber diameter: 13.1 μm) and the fiber 4 had 1.2 dtex (fiber diameter: 13.0 μm). The average fiber diameter of a pre-gel processing nonwoven sheet of the resultant separator was 7.81 μm. The average fiber diameter of the fibers other than the heat-and-humidity gelling resin was 9.52 μm.

### Example 3

An organic electrolyte battery separator was obtained with a process similar to that of Example 1, except that the fiber 1 had 3.3 dtex (post-split minor axis thickness: 3.96 μm (PP), 4.06 μm (EVOH)). The average fiber diameter of a pre-gel processing nonwoven sheet of the resultant separator was 6.78 μm. The average fiber diameter of the fibers other than the heat-and-humidity gelling resin was 7.68 μm.

### Example 4

An organic electrolyte battery separator was obtained with a process similar to that of Example 1, except that the fiber 1 having a fineness of 1.4 dtex was changed to 70 mass % (post-split minor axis thickness: 2.57 μm (PP), 2.66 μm (EVOH)) and the fiber 3 having 0.8 dtex was changed to 30 mass % (fiber diameter: 10.3 μm). The average fiber diameter of a pre-gel processing nonwoven sheet of the resultant separator was 4.92 μm. The average fiber diameter of the fiber other than the heat-and-humidity gelling resin was 6.13 μm.

### Example 5

50 mass % of the fiber 1 having a fineness of 1.2 dtex (post-split minor axis thickness: 2.2 μm (PP), 2.28 μm (EVOH)), 30 mass % of the fiber 3 having 0.8 dtex (fiber diameter: 10.3 μm), and 20 mass % of the fiber 4 having 0.6 dtex (fiber diameter: 8.37 μm) were mixed to prepare a water-dispersed slurry to a concentration of 0.5 mass %. From the water-dispersed slurry thus obtained, wetlaid webs having an mass per unit area of 12.5 g/m² was produced using a cylinder type wet papermaking machine and a short wire type wet papermaking machine. The two webs were combined together. Next, a thermal treatment was performed at 130° C. using a cylinder dryer, and at the same time, the heat-and-humidity gelling resin of the fiber 1 and the sheath component of the fiber 4 temporarily bonded the fibers. The wetlaid nonwoven sheet having an mass per unit area of 25 g/m² was rolled up. In the resultant wetlaid nonwoven sheet, substantially 100% of the fiber 1 was split and substantially uniformly dispersed in the nonwoven.

Next, the wetlaid nonwoven sheet was treated at room temperature (25° C.) for one minute in a processing chamber into which a gas mixture consisting of 1 volume % of fluorine, 73 volume % of oxygen, and 26 volume % of nitrogen had been introduced. Thereafter, the sheet was washed with ion-exchange water of 60° C., followed by drying at 70° C. using a hot air dryer. Thus, a hydrophilic nonwoven sheet was obtained. On the hydrophilic nonwoven sheet thus obtained, the contact angle of dechlorinated water was 0 degrees.

The hydrophilic nonwoven sheet was impregnated with water to 100 mass % with respect to the sheet by spraying. The sheet was subjected to gel processing using a pair of plane rollers heated to 90° C. (a thermal roller) with a line pressure of 8000 N/cm and a processing speed of 7 m/min. The sheet was subjected to thickness adjustment under the same conditions as those described above. Thus, an organic electrolyte battery separator of the present invention was obtained. In the thus-obtained separator, the average fiber diameter of the pre-gel processing nonwoven sheet was 5.88 μm, while the average fiber diameter of the fibers other than the heat-and-humidity gelling resin was 7.09 μm.

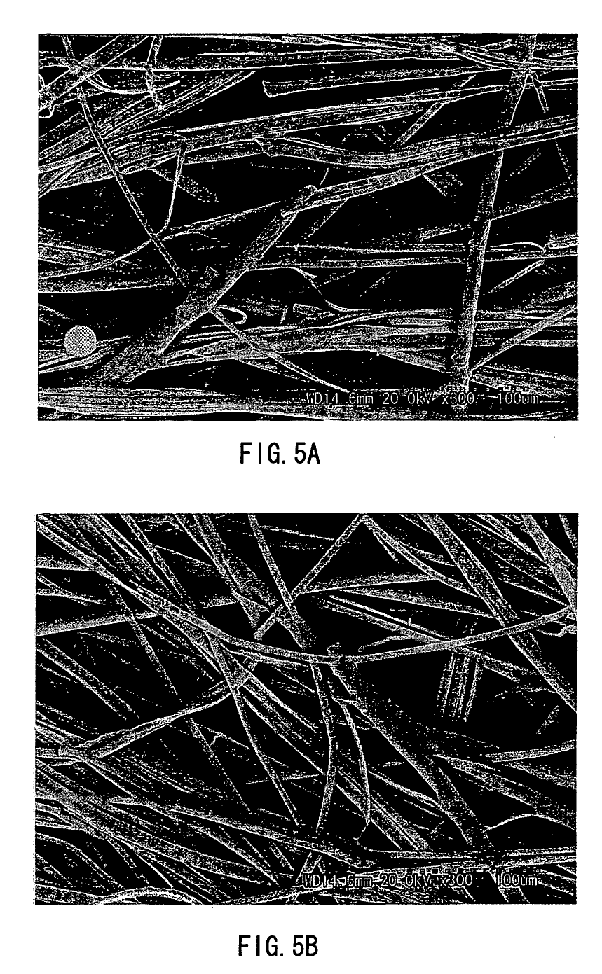

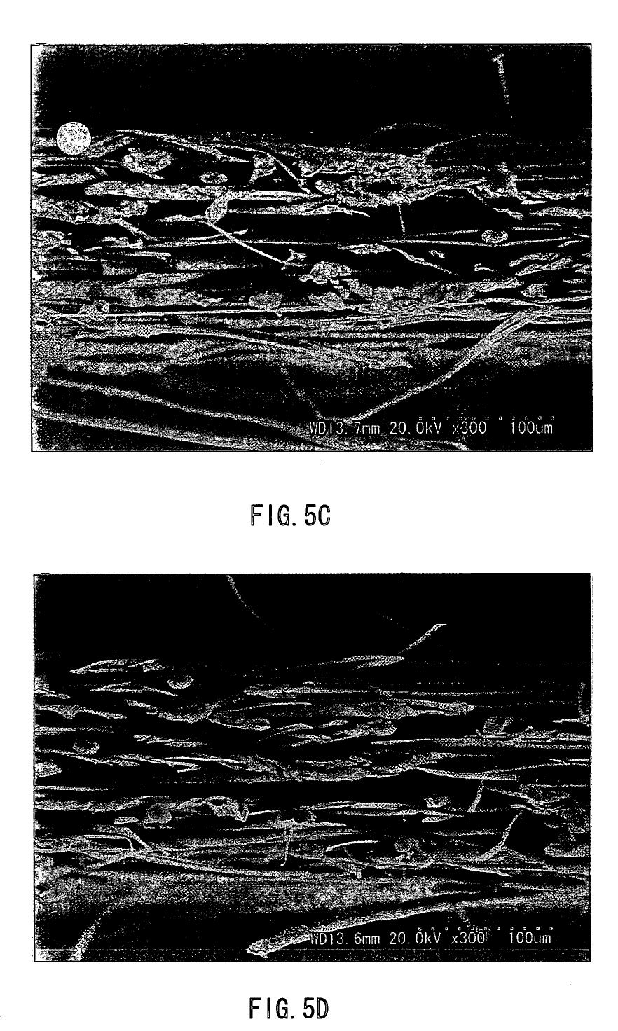

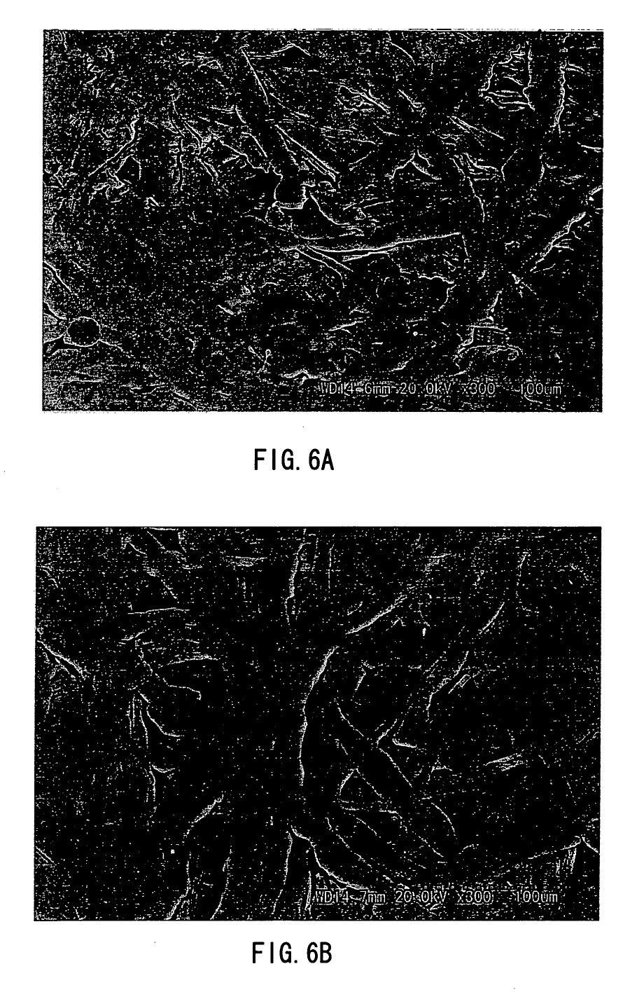

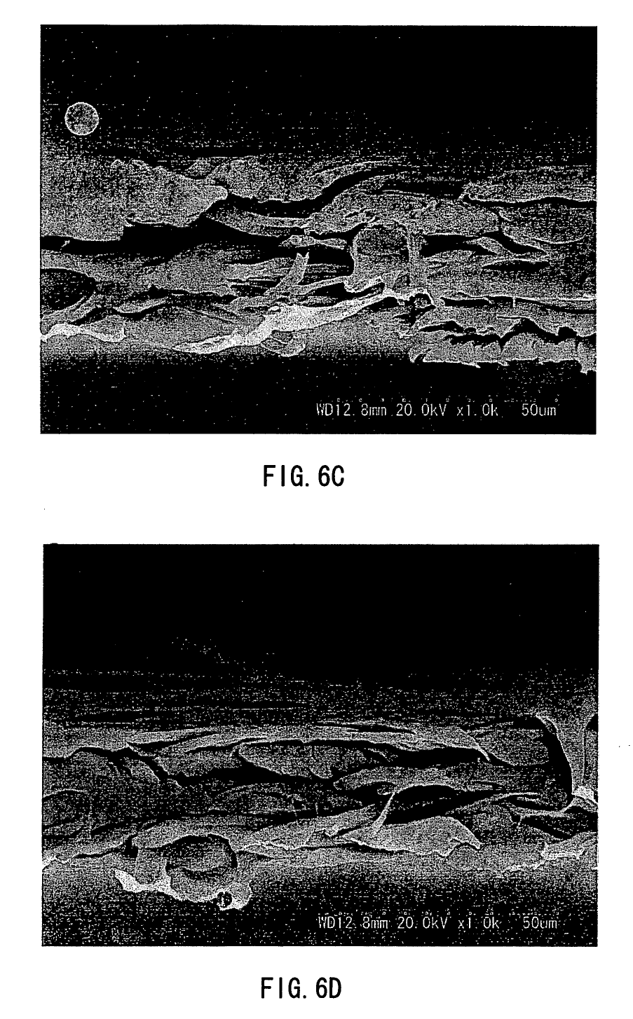

FIGS. 5A and 5B show 300×SEM micrographs of a surface of the nonwoven sheet. FIGS. 5C and 5D show 300× cross-sectional photographs thereof. Also, FIGS. 6A and 6B show 300×SEM micrographs of a surface of the separator. FIGS. 6C and 6D show 1000× cross-sectional photographs thereof.

### Example 6

An organic electrolyte battery separator was obtained by a process similar to that of Example 5, except that 50 mass % of the fiber 1 having a fineness of 1.2 dtex (post-split minor axis thickness: 2.2 μm (PP), 2.28 μm (EVOH)), 20 mass % of the fiber 3 having 0.8 dtex (fiber diameter: 10.3 μm), 10 mass % of the fiber 4 having 0.6 dtex (fiber diameter: 8.37 μm), and 20 mass % of a synthetic pulp were mixed. In the thus-obtained separator, the average fiber diameter (excluding the synthetic pulp) of the pre-gel processing nonwoven sheet was 5.02 μm, while the average fiber diameter of the fibers (excluding the synthetic pulp) other than the heat-and-humidity gelling resin was 6.27 μm.

### Comparative Example 1

An organic electrolyte battery separator was obtained by a process similar to that of Example 1, except that the separator was not impregnated with water. In this case, the separator was shrunk during thickness processing and was difficult to roll up.

### Comparative Example 2

An organic electrolyte battery separator was obtained by a process similar to that of Example 1, except that the fiber 3 had 2.0 dtex (fiber diameter: 16.8 μm) and the fiber 4 had 2.0 dtex (fiber diameter: 16.6 μm). In the thus-obtained separator, the average fiber diameter of the pre-gel processing nonwoven sheet was 9.66 μm, while the average fiber diameter of the fibers other than the heat-and-humidity gelling resin was 11.99 μm.

### Comparative Example 3

An organic electrolyte battery separator was obtained by a process similar to that of Example 1, except that the fiber 1 having a fineness of 1.4 dtex was changed to 20 mass % (post-split minor axis thickness: 2.57 μm (PP), 2.66 μm (EVOH)), the fiber 3 having 0.8 dtex was changed to 50 mass % (fiber diameter: 10.3 μm), and the fiber 4 having 0.6 dtex was changed to 30 mass % (fiber diameter: 8.37 μm). In the thus-obtained separator, the average fiber diameter of the pre-gel processing nonwoven sheet was 8.51 μm, while the average fiber diameter of the fibers other than the heat-and-humidity gelling resin was 9.16 μm.

### Comparative Example 4

An organic electrolyte battery separator was obtained by a process similar to that of Example 1, except that no hydrophilic treatment was performed before gel thickness processing. In this case, a contact angle of dechlorinated water was 105 degrees before gel processing, so that moisture was not uniformly permeated, resulting in non-uniform gelation.

### Comparative Example 5

The fiber 1 was changed to the fiber 2 having a fineness of 1.4 dtex (post-split minor axis thickness: 2.57 μm (PP), 2.70 μm (HDPE)). Thermal roller processing was performed at 130° C. without giving moisture. The resultant nonwoven was significantly shrunk during thickness processing, so that the sheet could not be rolled up.

Physical properties of the battery separators of Examples 1 to 6 and Comparative Examples 1 to 5 are shown in Tables 1 to 3.

TABLE 1

| | Example 1 | Example 2 | Example 3 | Example 4 |
|---|---|---|---|---|
| fiber type | fiber 1 | fiber 1 | fiber 1 | fiber 1 |
| composite ratio (core/sheath) | 50/50 | 50/50 | 50/50 | 50/50 |
| fineness (dtex) | 1.4 | 1.4 | 3.3 | 1.4 |
| post-split fineness (dtex) | 0.088 | 0.088 | 0.206 | 0.088 |
| post-split minor axis thickness (μm) | (PP)2.57 | (PP)2.57 | (PP)3.96 | (PP)2.57 |
| | (EVOH)2.66 | (EVOH)2.66 | (EVOH)4.06 | (EVOH)2.66 |
| content (mass %) | 50 | 50 | 50 | 70 |
| fiber type | fiber 3 | fiber 3 | fiber 3 | fiber 3 |
| fineness (dtex) | 0.8 | 1.20 | 0.8 | 0.8 |
| fiber diameter(μm) | 10.3 | 13.1 | 10.3 | 10.3 |
| content (mass %) | 30 | 30 | 30 | 30 |
| fiber type | fiber 4 | fiber 4 | fiber 4 | |
| fineness (dtex) | 0.6 | 1.2 | 0.6 | |
| fiber diameter(μm) | 8.37 | 13 | 8.37 | |
| content (mass %) | 20 | 20 | 20 | |
| fiber type | | | | |
| content (mass %) | | | | |
| heat-and-humidity gelling resin content (mass %) | 25 | 25 | 25 | 35 |
| average fiber diameter (μm) | 6.08 | 7.81 | 6.78 | 4.92 |
| average fiber diameter of other fibers (μm) | 7.22 | 9.52 | 7.68 | 6.13 |
| pre-gel processing hydrophilic treatment | Yes | Yes | Yes | Yes |
| moisture proportion (mass %) | 100 | 100 | 100 | 100 |
| thermal roller temperature (° C.) | 130 | 130 | 130 | 130 |
| thermal roller line pressure (N/cm) | 500 | 500 | 500 | 500 |
| post-gel processing shrinkage ratio (%) | 1 | 3 | 0.5 | 1 |
| mass per unit area (g/m²) | 30 | 30 | 30 | 30 |
| thickness (μm) | 47 | 49 | 53 | 43 |
| specific volume(cm³/g) | 1.56 | 1.63 | 1.77 | 1.43 |
| pre-gel processing mean flow pore diameter (μm) | 16.39 | 16.39 | 16.39 | 16.39 |
| pre-gel processing bubble point pore diameter (μm) | 26.61 | 26.61 | 26.61 | 26.61 |
| post-gel processing mean flow pore diameter (μm) | 1.69 | 3.89 | 2.56 | 1.38 |
| post-gel processing bubble point pore diameter (μm) | 7.38 | 16.3 | 12.01 | 6.91 |
| mean flow pore diameter reduction rate (%) | 89.7 | 77 | 84.4 | 91.6 |
| puncture strength (N) | 6.79 | 6.01 | 6.2 | 5.72 |
| standard deviation of puncture strength (N) | 0.57 | 0.72 | 0.65 | 0.52 |
| variation index of puncture strength | 0.084 | 0.120 | 0.105 | 0.091 |
| contact angle of pre-hydrophilic treatment | 105 | 105 | 105 | 105 |
| nonwoven sheet surface (degree) | | | | |
| contact angle of pre-hydrophilic treatment and | 0 | 0 | 0 | 0 |
| pre-gel processing nonwoven sheet surface (degree) | | | | |
| contact angle of post-gel processing separator | 0 | 0 | 0 | 0 |
| surface (degree) | | | | |
| proportion of film-like gel material portion (%) | 56 | 58 | 58 | 65 |

TABLE 2

| | | | Comparative | Comparative |
|---|---|---|---|---|
| | Example 5 | Example 6 | Example 1 | Example 2 |
| fiber type | Fiber 1 | fiber 1 | fiber 1 | fiber 1 |
| composite ratio (core/sheath) | 50/50 | 50/50 | 50/50 | 50/50 |
| fineness (dtex) | 1.2 | 1.2 | 1.4 | 1.4 |
| post-split fineness (dtex) | 0.075 | 0.075 | 0.088 | 0.088 |
| post-split minor axis thickness (μm) | (PP)2.20 | (PP)2.20 | (PP)2.57 | (PP)2.57 |
| | (EVOH)2.28 | (EVOH)2.28 | (EVOH)2.66 | (EVOH)2.66 |
| content (mass %) | 50 | 50 | 50 | 50 |
| fiber type | Fiber 3 | fiber 3 | fiber 3 | fiber 3 |
| fineness (dtex) | 0.8 | 0.8 | 0.8 | 2 |
| fiber diameter (μm) | 10.3 | 10.3 | 10.3 | 16.8 |
| content (mass %) | 30 | 30 | 30 | 30 |
| fiber type | Fiber 4 | fiber 4 | fiber 4 | fiber 4 |
| fineness (dtex) | 0.6 | 0.6 | 0.5 | 2 |
| fiber diameter(μm) | 8.37 | 8.37 | 8.37 | 16.6 |
| content (mass %) | 20 | 20 | 20 | 20 |
| fiber type | | synthetic | | |
| | | pulp | | |
| content (mass %) | | 20 | | |
| heat-and-humidity gelling resin content (mass %) | 25 | 25 | 25 | 25 |
| average fiber diameter (μm) | 5.88 | 5.02 | 6.08 | 9.66 |
| average fiber diameter of other fibers (μm) | 7.09 | 6.27 | 7.22 | 11.99 |
| pre-gel processing hydrophilic treatment | Yes | Yes | Yes | Yes |
| moisture proportion (mass %) | 100 | 100 | 0 | 100 |
| thermal roller temperature (° C.) | 90 | 90 | 130 | 130 |
| thermal roll line pressure (N/cm) | 8000 × 2 | 8000 × 2 | 500 | 500 |
| | times | times | | |
| post-gel processing shrinkage ratio (%) | 1 | 1 | 5 | 3 |
| mass per unit area (g/m²) | 25 | 20 | 30 | 30 |
| thickness (μm) | 35 | 30 | 47 | 58 |
| specific volume(cm³/g) | 1.4 | 1.5 | 1.57 | 1.93 |
| pre-gel processing mean flow pore diameter (μm) | 10.15 | 11.44 | 16.39 | 16.39 |
| pre-gel processing bubble point pore diameter (μm) | 20.19 | 21.06 | 26.61 | 26.61 |
| post-gel processing mean flow pore diameter (μm) | 3.36 | 3.21 | 6.23 | 8.24 |
| post-gel processing bubble point pore diameter (μm) | 12.94 | 9.15 | 21.2 | 21.1 |
| mean flow pore diameter reduction rate (%) | 66.9 | 71.9 | 62 | 49.7 |
| puncture strength (N) | 3.64 | 2.37 | 6.37 | 5.65 |
| standard deviation of puncture strength (N) | 0.51 | 0.38 | 1.34 | 0.98 |
| variation index of puncture strength | 0.140 | 0.160 | 0.210 | 0.173 |
| contact angle of pre-hydrophilic treatment | 105 | 105 | 105 | 105 |
| nonwoven sheet surface (degree) | | | | |
| contact angle of pre-hydrophilic treatment and | 0 | 0 | 0 | 0 |
| pre-gel processing nonwoven sheet surface (degree) | | | | |
| contact angle of post-gel processing separator | 0 | 0 | 0 | 0 |
| surface (degree) | | | | |
| proportion of film-like gel material portion (%) | 62 | 80 | 35 | 55 |

TABLE 3

| | Comparative | Comparative | Comparative |
|---|---|---|---|
| | Example 3 | Example 4 | Example 5 |
| fiber type | fiber 1 | fiber 1 | fiber 2 |
| composite ratio (core/sheath) | 50/50 | 50/50 | 50/50 |
| fineness (dtex) | 1.4 | 1.4 | 1.4 |
| post-split fineness (dtex) | 0.088 | 0.088 | 0.088 |
| post-split minor axis thickness (μm) | (PP)2.57 | (PP)2.57 | (PP)2.57 |
| | (EVOH)2.66 | (EVOH)2.66 | (PE)2.70 |
| content (mass %) | 20 | 50 | 50 |
| fiber type | fiber 3 | fiber 3 | fiber 3 |
| fineness (dtex) | 2 | 0.8 | 0.8 |
| fiber diameter(μm) | 16.8 | 10.3 | 10.3 |
| content (mass %) | 50 | 30 | 30 |
| fiber type | fiber 4 | fiber 4 | fiber 4 |
| fineness (dtex) | 2 | 0.5 | 0.5 |
| fiber diameter(μm) | 16.6 | 8.37 | 8.37 |
| content (mass %) | 20 | 20 | 20 |
| fiber type | | | |
| content (mass %) | | | |
| heat-and-humidity gelling resin content (mass %) | 10 | 25 | 0 |
| average fiber diameter(μm) | 8.51 | 6.08 | 6.09 |
| average fiber diameter of other fibers (μm) | 9.26 | 7.22 | 6.09 |
| pre-gel processing hydrophilic treatment | Yes | No | Yes |
| moisture proportion (%) | 100 | 100 | 100 |
| thermal roller temperature (° C.) | 130 | 130 | 130 |
| thermal roll line pressure (N/cm) | 500 | 500 | 500 |
| post-gel processing shrinkage ratio (%) | 5 | 5 | 8 |
| mass per unit area (g/m²) | 30 | 30 | not |
| thickness (μm) | 46 | 47 | measurable |
| specific volume (cm³/g) | 1.53 | 1.57 | |
| pre-gel processing mean flow pore diameter(μm) | 16.39 | 16.39 | 20.6 |
| pre-gel processing bubble point pore diameter (μm) | 26.61 | 26.61 | 46.2 |
| post-gel processing mean flow pore diameter(μm) | 7.76 | 3.89 | not |
| post-gel processing bubble point pore diameter (μm) | 54.61 | 23.32 | measurable |
| mean flow pore diameter reduction rate (%) | 52.7 | 76.3 | |
| puncture strength (N) | 6.02 | 6.37 | |
| standard deviation of puncture strength (N) | 0.98 | 1.33 | |
| variation index of puncture strength | 0.163 | 0.209 | |
| contact angle of pre-hydrophilic treatment | 105 | 105 | 115 |
| nonwoven sheet surface (degree) | | | |
| contact angle of pre-hydrophilic treatment | 40 | no | 50 |
| and pre-gel processing nonwoven sheet surface | | hydrophilic | |
| (degree) | | treatment | |
| contact angle of post-gel processing separator | 45 | 105 | no gel |
| (degree) | | | processing |
| proportion of film-like gel material portion (%) | 33 | 57 | |

As can be seen from Tables 1 to 3, it could be confirmed that in all of Examples 1 to 6, a nonwoven was obtained that has a small pore diameter, an appropriate mean flow pore diameter range and bubble point pore diameter range, and desired ranges of the standard deviation of the puncture strength and the film degree of the gel material while maintaining a satisfactory level of gel processing ability. In a separator comprising the nonwoven, the battery defect rate was low and no short circuits occurred. In Example 5, the thickness could be decreased up to 35 μm by increasing the line pressure of the thermal roller to 8000 N/cm. In Example 6, by adding a synthetic pulp, the thickness could be further decreased to 30 μm, whereby the bubble point pore diameter was also reduced to 10 μm or less.

On the other hand, in Comparative Example 1, the nonwoven was not impregnated with water, so that the heat-and-humidity gelling resin did not become a gel, and therefore, the pore diameter and thickness of the separator could not be reduced. Further, since moisture was not provided, the temperature of the thermal roller was applied directly to the nonwoven. As a result, the temperature of the sheath resin of the fiber 3 was greater than or equal to the melting point, so that the nonwoven was shrunk significantly. When the nonwoven was used as a separator, a fine powder short circuit occurred. In Comparative Example 2, since the fiber diameter was large, a small pore diameter was not obtained. Therefore, when the nonwoven was used as a separator, a fine powder short circuit occurred. In Comparative Example 3, the heat-and-humidity gelling resin content was small, and therefore, the heat-and-humidity gelling resin was not sufficiently spread between the fibers. As a result, the pore diameter, particularly the bubble point pore diameter, was not small. When such a nonwoven was used as a separator, a fine powder short circuit occurred. In Comparative Example 4, a hydrophilic treatment was not performed before gel thickness processing, and therefore, the nonwoven could not be provided with moisture uniformly, the bubble point pore diameter was not small and there was a significant variation in the puncture strength. When the nonwoven was used as a separator, a fine powder short circuit occurred. In Comparative Example 5, since the heat-and-humidity gelling resin was not used, the nonwoven was significantly shrunk during thickness processing, and therefore, was difficult to roll up.

Physical properties of the lithium ion secondary batteries of Example 1 and Comparative Example 4 are shown in Table 4.

TABLE 4

| | | | | Comparative |
|---|---|---|---|---|
| | | | Example 1 | Example 4 |
| short circuit characteristics | | | ◯ | X |
| safety | | | ◯ | X |
| self-discharge | Starting voltage (V) | | 3.7105 | not |
| amount | voltage after 4 hrs (V) | | 3.6241 | measurable |
| | voltage difference (V) | | 0.0564 | |
| electric | 0.5 C | discharge | 42.41 | not |
| capacity | | current 20 A | (100%) | measurable |
| output | 1.0 C | discharge | 42.11 | |
| characteristics | | current 40 A | (99.29%) | |
| (Ah) | 4.0 C | discharge | 41.02 | |
| | | current 80 A | (96.72%) | |
| | 6.0 C | discharge | 36.27 | |
| | | current 160 A | (85.52%) | |

Regarding the short circuit characteristics of a battery, when the resistance of the battery of Example 1 was measured using a mega electrical resistance meter before injection of electrolytic solution, the meter displayed ∞, i.e., a short circuit was not observed. On the other hand, in Comparative Example 4, when the resistance was measured, the meter did not display ∞, i.e., a short circuit occurred.

Regarding the safety of a battery, in Example 1, as the charge amount was increased, the cell voltage was linearly increased. When the battery is overcharged to 155% of the electric capacity, decomposed gas was generated from the bottom of the cell, but no other abnormality was observed. When the battery was further overcharged to 165%, generation of decomposed gas stopped and the test was ended. The battery held sufficient electrolytic solution to function as a battery again and abnormal rupture did not occur. Thus, it was confirmed that the battery was safely terminated. On the other hand, in Comparative Example 4, charge was continued before blockage occurred in the separator of the battery, so that an internal pressure was increased to a limit of the battery pack. Finally, gas and electrolytic solution suddenly burst and exploded.

Regarding the self-discharge amount and the electric capacity output characteristics of the battery, Example 1 provided satisfactory values, i.e., excellent battery characteristics. On the other hand, in Comparative Example 4, a short circuit occurred before producing the battery, i.e., a battery could not be obtained.

### INDUSTRIAL APPLICABILITY

The organic electrolyte battery separator of the present invention can be preferably useful for an organic electrolyte battery, particularly a lithium ion secondary battery. The organic electrolyte battery of the present invention can be used as a secondary battery for an ordinary consumer product, a hybrid electric vehicle (HEV) and a pure electric vehicle (PEV), and the like.

1-32. (canceled)

33. An organic electrolyte battery separator, which is composed of a nonwoven comprising a heat-and-humidity gelling resin capable of gelling by heating in the presence of moisture and another fiber,
the other fiber being fixed with a film gel material obtained by causing the heat-and-humidity gelling resin to gel under heat and humidity and be pressed and spread by pressing, and
the nonwoven having a mean flow pore diameter of 0.3 to 5 μm and a bubble point pore diameter of 3 to 20 μm as measured in accordance with ASTM F 316 86.

34. The organic electrolyte battery separator according to claim 33, wherein the heat-and-humidity gelling resin is a heat-and-humidity gelling fiber, the heat-and-humidity gelling resin being provided at least at a portion of a surface of the heat-and-humidity gelling fiber.

35. The organic electrolyte battery separator according to claim 33, wherein a proportion of the nonwoven occupied by the heat-and-humidity gelling resin is in a range of 10 to 50 mass %.

36. The organic electrolyte battery separator according to claim 33, wherein the heat-and-humidity gelling resin is an ethylene-vinyl alcohol copolymer.

37. The organic electrolyte battery separator according to claim 33, wherein the other fiber has a fiber diameter of 15 μm or less.

38. The organic electrolyte battery separator according to claim 33, wherein an average fiber diameter of the other fiber constituting the nonwoven is 10 μm or less.

39. The organic electrolyte battery separator according to claim 33, wherein the fiber constituting the nonwoven composed the heat-and-humidity gelling resin and an olefin fiber.

40. The organic electrolyte battery separator according to claim 33, wherein the other fiber includes a high-strength fiber having a single fiber strength of 4.5 cN/dtex or more in a range of 5 to 250 parts by mass where the heat-and-humidity gelling resin is assumed to be 100 parts by mass.

41. The organic electrolyte battery separator according to claim 33, wherein the other fiber includes a heat-melting fiber that does not substantially shrink at a temperature that causes the heat-and-humidity gelling resin to gel under heat and humidity to fix the other fiber, in a range of 10 to 300 parts by mass where the heat-and-humidity gelling resin is assumed to be 100 parts by mass.

42. The organic electrolyte battery separator according to claim 33, wherein the nonwoven further comprises a synthetic pulp in addition to the other fiber.

43. The organic electrolyte battery separator according to claim 33, wherein the synthetic pulp is included in a range of 10 to 200 parts by mass where the heat-and-humidity gelling resin is assumed to be 100 parts by mass.

44. The organic electrolyte battery separator according to claim 34, wherein an average fiber diameter of the heat-and-humidity gelling fiber and the other fiber is 10 μm or less.

45. The organic electrolyte battery separator according to claim 34, wherein the heat-and-humidity gelling fiber has a fiber diameter of 1 to 6 μm.

46. The organic electrolyte battery separator according to claim 45, wherein the heat-and-humidity gelling fiber is a fiber provided by splitting a splittable composite fiber that contains the heat-and-humidity gelling resin and another resin, which are adjacent to each other in a cross-section of the fiber.

47. The organic electrolyte battery separator according to claim 46, wherein, when the splittable composite fiber comprised of the heat-and-humidity gelling resin and another resin, which are adjacent to each other in a cross-section of the fiber, to be able to provide the heat-and-humidity gelling fiber, is assumed to be 100 parts by mass,
the nonwoven comprises, as the other fiber, a high-strength fiber having a single fiber strength of 4.5 cN/dtex or more in a range of 10 to 200 parts by mass, and
the nonwoven further comprises a heat-melting fiber that does not substantially shrink at a temperature that causes the heat-and-humidity gelling resin to gel under heat and humidity to fix the other fiber, in a range of 10 to 200 parts by mass.

48. The organic electrolyte battery separator according to claim 46, wherein, when the splittable composite fiber comprised of the heat-and-humidity gelling resin and another resin, which are adjacent to each other in a cross-section of the fiber, to be able to provide the heat-and-humidity gelling fiber, is assumed to be 100 parts by mass,
the nonwoven comprises, as the other fiber, a high-strength fiber having a single fiber strength of 4.5 cN/dtex or more in a range of 6.25 to 120 parts by mass,
the nonwoven further comprises a heat-melting fiber that does not substantially shrink at a temperature that causes the heat-and-humidity gelling resin to gel under heat and humidity to fix the other fiber, in a range of 12.5 to 120 parts by mass, and
the nonwoven further comprises the synthetic pulp in a range of 6.25 to 120 parts by mass.

49. The organic electrolyte battery separator according to claim 34, wherein the fiber constituting the nonwoven is a short fiber having a fiber length in a range of 1 mm to 20 mm, and the nonwoven is a wetlaid nonwoven obtained by a wetlaying process using the short fiber.

50. The organic electrolyte battery separator according to claim 49, wherein the splittable composite fiber is split during the wetlaying step to provide a heat-and-humidity gelling fiber, and the heat-and-humidity gelling fiber is substantially uniformly present in the nonwoven.

51. The organic electrolyte battery separator according to claim 33, wherein a surface of the nonwoven is partially covered with a film gel material.

52. The organic electrolyte battery separator according to claim 51, wherein an area proportion of the film gel material with respect to an entire surface of the nonwoven is in a range of 40% to 90%.

53. The organic electrolyte battery separator according to claim 33, wherein a contact angle of dechlorinated water dropped on a surface of the nonwoven is 60 degrees or less 5 seconds after dropping of the dechlorinated water.

54. The organic electrolyte battery separator according to claim 33, wherein the nonwoven has a puncture strength of 2 N or more and a standard deviation of 1.1 N or less.

55. The organic electrolyte battery separator according to claim 54, wherein a variation index of the puncture strength of the nonwoven is 0.165 or less, the variation being calculated from the puncture strength and the standard deviation using the following expression:
variation index of puncture strength=standard deviation/puncture strength.

56. The organic electrolyte battery separator according to claim 33, wherein the separator has a thickness in a range of 15 μm to 80 μm and the nonwoven has a specific volume in a range of 1.2 cm³/g to 2.5 cm³/g.

57. A method for producing an organic electrolyte battery separator, which is composed of a nonwoven comprising a heat-and-humidity gelling fiber in which a resin capable of gelling by heating in the presence of moisture is present on at least a portion of a surface of the fiber, and another fiber, the method comprising at least all of the following steps A to D of:
A. preparing a nonwoven sheet comprising the heat-and-humidity gelling fiber and the other fiber;
B. subjecting the nonwoven sheet to a hydrophilic treatment;
C. providing moisture to the hydrophilic-treated nonwoven sheet to obtain a water-containing sheet; and
D. subjecting the water-containing sheet to gel processing by pressing and a heat-and-humidity treatment using a heat treatment device that is set to a certain temperature within a range of no less than a temperature at which the heat-and-humidity gelling resin gels and no more than “the melting point of the heat-and-humidity gelling resin −20° C.”, to cause the heat-and-humidity gelling resin to gel and be pressed and spread to form a film, and fixing the other fiber using the heat-and-humidity gelling resin gel.

58. The organic electrolyte battery separator producing method according to claim 57, wherein the average fiber diameter of the nonwoven sheet is 10 μm or less.

59. The organic electrolyte battery separator producing method according to claim 57, wherein a proportion of the moisture provided to the hydrophilic-treated nonwoven sheet is in a range of 20 mass % to 300 mass %.

60. The organic electrolyte battery separator producing method according to claim 57, wherein a contact angle of dechlorinated water dropped on a surface of the hydrophilic-treated nonwoven sheet is 60 degrees or less 5 seconds after dropping of the dechlorinated water

61. The organic electrolyte battery separator producing method according to claim 57, wherein the hydrophilic treatment is an exposure to fluorine gas atmosphere.

62. The organic electrolyte battery separator producing method according to claim 57, wherein the gel processing is press processing using a thermal roller, and a line pressure of the thermal roller is in a range of 350 N/cm to 10000 N/cm.

63. An organic electrolyte battery comprising the separator according to claim 33.
